(19) United States
(12) Patent Application Publication
(10) Pub. No.: US 2005/0239990 A1
(43) Pub. Date: Oct. 27, 2005

(54) Curable resin composition for optical waveguide, curable dry film for formal optical waveguide, optical waveguide, and, method for forming optical waveguide

(76) Inventors: Takahiro Higuchi, Kanagawa (JP); Genji Imai, Kanagawa (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/018,085

(22) Filed: Dec. 20, 2004

(30) Foreign Application Priority Data
Dec. 25, 2003 (JP) 2003-429759
Dec. 25, 2003 (JP) 2003-429760
Jul. 29, 2004 (JP) 2004-222480
Jul. 29, 2004 (JP) 2004-222481

(51) Int. Cl. C08G 18/00

(52) U.S. Cl. 528/44

(57) ABSTRACT

A curable resin composition for optical waveguide comprising, as essential components, a carboxyl group-containing urethane compound (A), a polymerizable unsaturated compound (B), a compound (C) containing two or more ring-opening polymerizable functional groups in the molecule, and, a radiation polymerization initiator (D); and, a method for forming an optical waveguide comprising, laminating a dry film composed of a thermosetting resin composition on the surface of a lower clad layer (I) and a core part (II) by heating, and curing this to form an upper clad layer (III), wherein Tg of the dry film is lower by 10° C. or more than Tg of the cured resin forming the core part (II), and the laminating temperature of the dry film is higher by 10° C. or more than Tg of the dry film, are disclosed.

### BACKGROUND OF THE INVENTION

1. Field of the Invention

The present invention relates to a curable resin composition for optical waveguide, a curable dry film for forming optical waveguide and an optical waveguide obtained by using them, further, to a method for forming an optical waveguide and an optical waveguide obtained by this method.

2. Description of the Prior Art

Recently, due to requirements for increased capacity and enhanced speed of information treatment in optical communication systems and computers, an optical waveguide is paid to attention as a light transmission medium. As such a light transmission medium, quarts-based waveguides are typical, however, there are problems that a special production apparatus is necessary and production time is long, and the like.

There is a suggestion on a method in which a dry film containing a radiation polymerizable component is laminated on a base material, irradiated with given amount of light, and given portions are cured with radiation and if necessary, un-exposed portions are developed to form a core part and the like, thus, an optical waveguide excellent in a transmission property is produced. Namely, there is a suggestion on a radiation curable dry film for forming optical waveguide capable of forming an optical waveguide in a short period of time and at low cost only by laminating a film on a base material, irradiating the film with given amount of light, then, developing this, and a method for forming an optical waveguide using this film (see, Japanese Patent Application Laid-Open (JP-A) No. 2003-202437), as substitutes for the above-mentioned quarts-based waveguide and production method thereof.

As a resin composition for forming an optical waveguide, a resin composition for optical waveguide comprising an ethylenically unsaturated group-containing carboxylic acid resin having at least one ethylenically unsaturated group and at least one carboxyl group in the molecule, a diluent, and a photo-polymerization initiator is known (see, JP-A No. 2003-149475).

JP-A No. 2003-202437 describes a copolymer obtained from a radical polymerizable compound having a carboxyl group and other radical polymerizable compound and having a glass transition temperature of 20 to 150° C., as the alkali-developable carboxyl group-containing resin component constituting the dry film described therein.

However, if the above-described carboxyl group-containing resin is used as a dry film for forming optical waveguide and when handling works are conducted such as painting the above-mentioned composition on peeling paper made of PET and the like and laminating the composition, winding the laminated dry film, and laminating the film on a base material to form an optical waveguide, there may be a case in which the above-mentioned dry film manifests defects such as crack and fracture to decrease the performance of the optical waveguide. Further, in the technology described in the above-mentioned publication, when an upper clad layer is formed using a dry film on the surface of a lower clad layer and core part, there may be a case in which a gap is generated between a dent part of a convex part of the core part and the upper clad layer, a core shape as designed is not obtained and a sufficient transmission property is not obtained.

Though JP-A No. 2003-149475 has no description of use of the resin composition for optical waveguide described therein as a dry film for forming optical waveguide, even if this is used as a dry film for forming optical waveguide, there may be a case in which a dry film manifests defects such as crack and fracture to decrease the performance of an optical waveguide when handling works are conducted such as painting the composition on peeling paper made of PET and the like and laminating the composition, winding the laminated dry film, and laminating the film on a base material to form an optical waveguide, like that described in JP-A No. 2003-202437. Also when the resin composition for optical waveguide described in JP-A No. 2003-149475 is used as a solution, there may be a case in which the finally obtained optical waveguide does not have sufficient mechanical properties such as processability an bending, consequently, defects such as crack and fracture occurs in attaching the resulted optical waveguide to a necessary place, or working the resulted optical waveguide, to lower the performance of the optical waveguide. Furthermore, when an upper clad layer is formed using a dry film on the surface of a lower clad layer and core part, there may be a case in which a gap is generated between a dent part of a convex part of the core part and the upper clad layer, a core shape as designed is not obtained and a sufficient transmission property is not obtained, like that described in JP-A No. 2003-202437.

### SUMMARY OF THE INVENTION

A first object of the present invention is to provide a curable dry film for forming optical waveguide capable of giving an optical waveguide particularly without decreasing the processability and mechanical nature of a painted film, a curable resin composition used for this, and an optical waveguide obtained by using this.

A second object of the present invention is to provide a method for forming an optical waveguide particularly capable of giving a core shape as designed and a sufficient transmission property, and an optical waveguide obtained by this method.

The first object of the present invention is attained by a first aspect of the present invention (curable resin composition for optical waveguide, dry film and optical waveguide) mentioned below.

A curable resin composition for optical waveguide comprising, as essential components, a carboxyl group-containing urethane compound (A), a polymerizable unsaturated compound (B), a compound (C) containing two or more ring-opening polymerizable functional groups in the molecule, and, a radiation polymerization initiator (D).

A dry film for forming an optical waveguide composed of a curable resin composition comprising, as essential components, a carboxyl group-containing urethane compound (A), a polymerizable unsaturated compound (B), a compound (C) containing two or more ring-opening polymerizable functional groups in the molecule, and, a radiation polymerization initiator (D), and the dry film has a softening temperature of 0° C. to 80° C.

An optical waveguide formed by using a dry film having a lower clad layer, core part and upper clad layer wherein at least one of these lower clad layer, core part and upper clad layer is composed of a curable resin composition comprising, as essential components, a carboxyl group-containing urethane compound (A), a polymerizable unsaturated compound (B), a compound (C) containing two or more ring-opening polymerizable functional groups in the molecule, and, a radiation polymerization initiator (D), and the dry film has a softening temperature of 0° C. to 80° C.

The second object of the present invention is attained by a second aspect of the present invention (method for forming optical waveguide, and optical waveguide) mentioned below.

A method for forming an optical waveguide comprising, forming a core part (II) composed of a cured resin on the surface of a lower clad layer (I), laminating a dry film composed of a thermosetting resin composition on the surface of the lower clad layer (I) and core part (II) by heating, and, curing the film to form an upper clad layer (III), wherein the glass transition temperature of said dry film is lower by 10° C. or more than the glass transition temperature of the cured resin forming the core part (II), and the laminating temperature of said dry film is higher by 10° C. or more than the glass transition temperature of the dry film.

An optical waveguide obtained by the above-mentioned method for forming an optical waveguide.

The composition according to the first aspect of the present invention is constituted of a specific composition, consequently, an optical waveguide composed of a lower clad layer, core part and upper clad layer and revealing low transmission loss is obtained. By making this curable resin composition for optical waveguide into a dry film, all of the upper clad layer, core part and upper clad layer can be manufactured using a dry film, and an optical waveguide can be formed easily in a short period of time at high precision, without losing a mechanical nature. This composition is suitable as a material of a curable dry film for forming optical waveguide capable of giving an optical waveguide without particularly lowering processability and mechanical nature of a painted film.

In the method for forming an optical waveguide according to the second aspect of the present invention, particularly by setting the glass transition temperature of a dry film for forming an upper clad layer (III) lower than the glass transition temperature of a cured resin forming a core part (II) by 10° C. or more, a dent part at a convex part of the core part can be filled sufficiently with a dry film, consequently, an optical waveguide is obtained showing no fear of decrease in transmission property by generation of a gap between the core part and the upper clad layer (see, FIG. 4) or deformation of the core part due to pressure in laminating (see, FIG. 6).

Also by setting the temperature in laminating a dry film for forming the upper clad layer (III) on the surface of the lower clad layer (I) and core part (II) by heating, lower than the glass transition temperature of a cured resin forming the upper clad layer (III) (glass transition temperature of dry film) by 10° C. or more, a dent part at a convex part of the core part can be filled sufficiently with the dry film and an optical waveguide excellent in a transmission property is obtained without generation of a gap between the core part and the clad layer.

In the method for forming an optical waveguide according to the second aspect of the present invention, after laminating a dry film for forming the upper clad layer (III) on the surface of the lower clad layer (I) carrying the provided core part (II) so as to cover them, pre-bake and post-bake may be conducted to cure the dry film to form the upper clad layer (III). By conducting pre-bake, a dry film can be filled in a dent part at a convex part of the core part (II) completely without gap, then, by completely curing the dry film by post-bake to obtain the upper clad layer (III), a reliable optical waveguide can be formed. As a thermosetting resin composition for obtaining such an effect by pre-bake and post-bake, those containing a heat latent catalyst and/or light latent catalyst for controlling curing period by temperature condition and irradiation with light are preferable.

For example, that obtained by compounding a light latent catalyst in a thermosetting resin composition containing a carboxyl group-containing resin and an epoxy resin as a resin component does not function as a catalyst at temperatures lower than the dissociation temperature, and the composition is not cured. By thus conducting pre-bake at temperatures causing no dissociation of a light latent catalyst, the composition causes flowing and a dent part at a convex part of the core part (II) can be completely filled.

Thereafter, by irradiating the whole surface of a lamination surface of a dry film subjected to pre-bake treatment with active energy ray, a light latent catalyst can be activated, and by conducting post-bake at temperatures of the dissociation temperature or higher, a dry film can be completely cured to form the upper clad layer (III) and a reliable optical waveguide can be formed.

A light latent catalyst needs only irradiation with active energy ray for generating an active species, and a time required for post-bake is shorter as compared with a heat latent catalyst, therefore, a light latent catalyst is more preferable. Further, a light latent catalyst can also be dissociated by heat, therefore, also by elongating the post-bake time after pre-bake, a layer as the upper clad layer (III) can be completely cured and a reliable optical waveguide can be formed.

In the method for forming an optical waveguide according to the present invention, a difference in refractive index of the core part (II) from the clad layers (I) and (III) can be set depending on the function and property of the intended optical waveguide, and it is preferable that a difference in refractive index of them is 0.1% or more. Namely, by setting a difference in refractive index of the core part (II) from the clad layers (I) and (III) at 0.1% or more, an optical waveguide excellent in a transmission property can be formed.

The optical waveguide according to the second aspect of the present invention is an optical waveguide obtained by the above-mentioned method for forming an optical waveguide. This optical waveguide is obtained particularly by the above-mentioned special forming method, that is, it is an optical waveguide excellent in processability and transmission property.

### BRIEF DESCRIPTION OF DRAWINGS

FIG. 1 is a sectional view viewed from the direction of the side surface (thickness) and upper surface of an optical waveguide according to the present invention.

FIG. 2 shows a sectional view viewed from the front direction of the section in FIG. 1.

FIG. 3 shows a method for forming an optical waveguide according to the present invention.

FIG. 4 is a sectional view viewed from the front direction of a section of an optical waveguide according to a conventional technology.

FIG. 5 is a sectional view viewed from the front direction of a section of an optical waveguide formed by Examples 2-1,2-2 and 2-3.

FIG. 6 is a sectional view viewed from the front direction of a section of an optical waveguide formed by Comparative Example 2-1.

FIG. 7 is a sectional view viewed from the front direction of a section of an optical waveguide formed by Comparative Example 2-2.

### DETAILED DESCRIPTION OF THE PREFERRED EMBODIMENTS

First, a preferred embodiment according to the first aspect of the present invention will be illustrated.

A curable resin composition for optical waveguide according to the first aspect of the present invention comprises, as essential components, a carboxyl group-containing urethane compound (A) (hereinafter, abbreviated simply as “compound (A)” in some cases), a polymerizable unsaturated compound (B) (hereinafter, abbreviated simply as “compound (B)” in some cases), a compound containing two or more ring-opening polymerizable functional groups in the molecule (C) (hereinafter, abbreviated simply as “compound (C)” in some cases), and a radiation polymerization initiator (D) (hereinafter, abbreviated simply as “initiator (D)” in some cases).

Carboxyl Group-Containing Urethane Compound (A):

It is preferable that the compound (A) is specifically a reaction product of a polyhydroxycarboxylic acid compound (a) having two or more hydroxyl groups in one molecule and one or more carboxyl groups in one molecule with a polyisocyanate compound (b).

Specific examples of the polyhydroxycarboxylic acid compound (a) include 2,2-dimethylolpropionic acid, 2,2-dimethylolacetic acid, 2,2-dimethylolpentanoic acid, or, semi-ester compounds obtained by reaction of a triol compound and an acid anhydride compound, sulfonate diol compounds obtained by transesterification of sodium dimethylsulfoisophthalate and glycols under glycols excess conditions, and the like, and these compounds may be used singly or in combination of two or more.

The polyisocyanate compound (b) includes, specifically, aliphatic diisocyanate compounds, for example, hexamethylene diisocyanate, trimethylene diisocyanate, 1,4-tetramethylene diisocyanate, pentamethylene diisocyanate, 1,2-propylene diisocyanate, 1,2-butylene diisocyanate, trimethylhexamethylene diisocyanate, dimer acid diisocyanate, lysine diisocyanate, 2,3-butylene diisocyanate, 1,3-butylene diisocyanate and the like; alicyclic diisocyanate compounds, for example, isophorone diisocyanate, 4,4′-methylenebis(cyclohexyl isocyanate), methylcylohexane-2,4-(or -2,6-)diisocyanate, 1,3-(or 1,4-)di(isocyanatomethyl)cyclohexane, 1,4-cyclohexane diisocyanate, 1,3-cyclopentane diisocyanate, 1,2-cyclohexane diisocyanate and the like; aromatic diisocyanate compounds, for example, xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluidine diisocyanate, 4,4′-diphenyl ether diisocyanate, (m- or p-)phenylene diisocyanate, 4,4′-biphenylene diisocyanate, 3,3′-dimethyl-4,4′-biphenylene diisocyanate, bis(4-isocyanatophenyl)sulfone, isopropylidenebis(4-phenyl isocyanate); other polyisocyanates, for example, polyisocyanate compounds having tree or more isocyanate groups such as triphenylmethane-4,4′,4″-triisocyanate, 1,3,5-triisocyanatobenzene, 2,4,6-triisocyanatotoluene and 4,4′-dimethyldiphenylmethane-2,2′-5,5′-tetraisocyanate, adducts obtained by reacting a polyol such as ethylene glycol, propylene glycol, 1,4-butylene glycol, polyalkylene glycol, trimethylolpropane and hexanetriol with a polyisocyanate compound so that the amount of the isocyanate group is excess based on a hydroxyl group of the polyol, biuret type adducts such as hexamethylene diisocyanate, isophorone diisocyanate, tolylene diisocyanate, xylylene diisocyanate, 4,4-diphenylmethane diisocyanate and 4,4′-methylenebis(cyclohexyl isocyanate), isocyanuric ring type adducts, and the like. These can be used singly or in combination of two or more.

Of these compounds, particularly aromatic diisocyanate compounds are not easily hydrolyzed in an alkali developer and can form a light curing film showing strong resistance against an alkaline developer and etching solution, further, the film itself is tough, consequently, until peeling of a light-cured resist film in a resist pattern formation method, the aromatic diisocyanate compounds adhere sufficiently without peeling from a base material for example by outer force of an etching solution and the like, therefore, aromatic diisocyanate compounds are preferable.

If necessary, a polyol compound can be compounded, in addition to the above-mentioned compounds.

A polyol compound introduces a hydrophobic group containing no carboxyl group in the molecule into the molecule main chain to adjust balance between hydrophilicity and hydrophobicity in a polyurethane compound, and an akylene glycol (number-average molecular weight: about 500 to 5000) or the like itself has hydrophilicity, however, this can render a resist film soft, therefore, it can improve film performances such as an alkali developing property and etching resistance.

Specific examples of the polyol compound include (poly)methylene glycol, (poly)ethylene glycol, (poly)propylene glycol, 1,4-butanediol, 1,3-butanediol, 2,3-butanediol, 1,2-butanediol, 3-methyl-1,2-butanediol, 1,2-pentanediol, 1,5-pentanediol, 1,4-pentanediol, 2,4-pentanediol, 2,3-dimethyltrimethylene glycol, 3-methyl-4,3-pentanediol, 3-methyl-4,5-pentanediol, 2,2,4-trimethyl-1,3-pentanediol, 1,6-hexanediol, 1,5-hexanediol, 1,4-hexanediol, 2,5-hexanediol, 1,4-cyclohexanedimethanol, neopentyl glycol, pentaerythritol, trimethylolpropane and glycerol. These can be used singly or in combination of two or more.

The compound (A) can be produced by the same known method as for general polyurethane resins. Namely, a carboxyl group-containing polyol compound (a), a polyisocyanate compound (b), and if necessary, a mixture with a polyol compound are compound so that the amount of a hydroxyl group is equivalent to or more than the amount of an isocyanate group (for example, isocyanate group/hydroxyl group=about 1.1 to 2.0 molar ratio, preferably about 1.2 to 1.9 molar ratio) and isocyanate groups and hydroxyl groups are allowed to perform an addition reaction, to produce a carboxyl group-containing isocyanate compound.

The above-mentioned carboxyl group is, before reaction, previously blocked by esterification with a lower alcohol such as, for example, methanol, ethanol and propanol, then, this lower alcohol is, after reaction, removed by heating, thus, a carboxyl group can be regenerated.

The temperature of the reaction system of an addition reaction of an isocyanate group and a hydroxyl group is usually 50 to 150° C. If necessary, a urethane reaction catalyst may be advantageously used. As the urethane reaction catalyst, there are organotin compounds such as tin octylate and dibutyltin dilaurate.

The compound (A) can contain a polymerizable unsaturated group, if necessary. Specifically, for example, a part of carboxyl groups contained in the compound (A) can be reacted with a reactive group such as an epoxy group or isocyanate group reacting with the carboxyl group, and an unsaturated compound containing a radical polymerizable unsaturated group such as an acryloyl group, methacryloyl group or vinyl group to introduce an unsaturated group. Regarding such an unsaturated compound, examples of the epoxyl group-containing unsaturated compound include glycidyl(meth)acrylate, isocyanate ethyl(meth)acrylate, and the like.

The compound (A) has, particularly, a number-average molecular weight of about 1000 to 200000, preferably about 2000 to 80000. When the number-average molecular weight is less than about 1000, the processability of a dry film lowers, while when over 200000, though a dry film is in general heated in laminating the dry film on a base material, decrease in viscosity by this heating is small, therefore, laminating workability lowers and after laminating, foaming occurs to deteriorate the performance. The compound (A) preferably has a softening temperature of 0 to 120° C., particularly 20 to 100° C. When the softening temperature is lower than 0° C., a dry film cannot be formed and a film manifests stickiness, consequently, disadvantages occur in lamination on a base material. On the other hand, when over 120° C., a film becomes hard or brittle, leading to decrease in a transferring property.

In this specification, the softening temperature (TMA) was measured by the thermal deformation behavior of a sheet having a thickness of 1 mm using Thermomechanical Analyser manufactured by Dupon. Namely, a quartz needle was placed on a sheet, a load of 49 g was applied thereon and temperature was raised at a rate of 5° C./min., and temperature at which the needle penetrated by 0.635 mm was defined as TMA.

The compound (A) preferably has a carboxyl group content of 30 to 180, particularly 40 to 120, in terms of acid value (mg/g KOH). When the acid value of the compound (A) is less than 30, developability by an alkali developer lowers and an optical waveguide having excellent performance cannot be formed easily. On the other hand, when over 180, solubility by an alkali developer increases too much, therefore, a sharp optical waveguide cannot be formed easily.

Polymerizable unsaturated compound (B):

Examples of the compound (B) include alkyl or cycloalkyl ester monomers of (meth)acrylic acid such as methyl(meth)acrylate, ethyl(meth)acrylate, propyl (meth)acrylate, n-butyl(meth)acrylate, isobutyl(meth)acrylate, tert-butyl(meth)acrylate, 2-ethylhexyl(meth)acrylate, cyclohexyl(meth)acrylate, n-octyl(meth)acrylate, lauryl(meth)acrylate, dodecyl(meth)acrylate, stearyl(meth)acrylate, 2-ethylhexyl carbitol (meth)acrylate and isobornyl(meth)acrylate; alkoxyalkyl ester monomers of (meth)acrylic acid such as methoxybutyl(meth)acrylate, methoxyethyl (meth)acrylate, ethoxybutyl(meth)acrylate and trimethylolpropane tripropoxy (meth)acrylate; aromatic vinyl monomers such as styrene, α-methylstyrene and vinyltoluene; α,β-ethylenically unsaturated carboxylic acid monomers such as (meth)acrylic acid and maleic acid; acryl phosphate ester monomers such as dimethyl phosphate ethyl acrylate and diethyl phosphate ethyl acrylate; epoxy group-containing unsaturated monomers such as glycidyl(meth)acrylate, 3,4-epoxycyclohexyl methyl(meth)acrylate and glycidyl ether; hydroxyl group-containing unsaturated monomers such as 2-hydroxyethyl(meth)acrylate, 2-hydroxypropyl(meth)acrylate, 2-hydroxy-3-phenoxypropyl(meth)acrylate, 3-hydroxypropyl(meth)acrylate, hydroxybutyl (meth)acrylate, (poly)alkylene glycol monoacrylate and adducts of these monomers with lactone (for example, ε-caprolactone); esters of aromatic alcohol and (meth)acrylic acid such as benzyl(meth)acrylate; adducts of glycidyl(meth)acrylate or a hydroxyalkyl ester of (meth)acrylic acid with a monocarboxylic acid compound such as capric acid, lauric acid, linolic acid and oleic acid, adducts of (meth)acrylic acid with a monoepoxy compound such as “Cardula E10” (manufactured by Shell Chemical); chain alkyl vinyl ethers such as ethyl vinyl ether, propyl vinyl ether, butyl vinyl ether, hexyl vinyl ether and octyl vinyl ether; cycloalkyl vinyl ethers such as cyclopentyl vinyl ether, cyclohexyl vinyl ether and 1,4-cyclohexane dimethanol divinyl ether; allyl ethers such as allyl glycidyl ether and allyl ethyl ether; fluorine-containing unsaturated monomers such as perfluorobutyl ethyl(meth)acrylate, perfluoroisononyl ethyl(meth)acrylate and perfluorooctyl ethyl(meth)acrylate; nitrogen-containing unsaturated monomers such as (meth)acryloylmorpholine, 2-vinylpyridine, 1-vinyl-2-pyrrolidone, vinylcaprolactam, dimethyl(meth)acrylamide, N,N-dimethyl ethyl(meth)acrylate and diacetoneacrylamide; polyhydric alcohol-modified polyfunctional monomers such as ethylene glycil di(meth)acrylate, diethylene glycol di(meth)acrylate, triethylene glycol di(meth)acrylate, tetra or more poly(4 to 16)ethylene glycol di(meth)acrylate, propylene glycol di(meth)acrylate, trimethylolpropane tri(meth)acrylate, pentaerythritol tetra(meth)acrylate, ethylene glycol diitaconate and ethylene glycol dimaleate; other hydroquinone di(meth)acrylate, resorcinol di(meth)acrylate, pyrogallol (meth)acrylate; unsaturated group-containing resins (adducts of polyester polyol with (meth)acrylic acid, specifically, Aronix M-8100, 8030 and the like (manufactured by Toagosei Co., Ltd., trade name)). The above-mentioned unsaturated compounds can be used singly or in combination of two or more.

Compound Containing Two or More Ring-Open Polymerizable Functional Groups in the Molecule (C):

As the compound (C): compounds having two or more cyclic ethers in the molecule are preferable. These compounds include oxylane compounds, oxetane compounds, oxolane compounds and the like. Specifically, examples of oxylane compounds include 3,4-epoxycyclohexylmethyl-3′,4′-epoxycyclohexane carboxylate, 2-(3,4-epoxycyclohexyl-5,5-spiro-3,4-epoxy)cyclohexane-meth-dioxane, bis(3,4-epoxycyclohexylmethyl) adipate, vinylcyclohexene oxide, 4-vinylepoxycyclohexane, bis(3,4-epoxy-6-methylcyclohexylmethyl) adipate, 3,4-epoxy-6-methylcyclohexyl-3′,4′-epoxy-6′-methylcyclohexane carboxylate, methylenebis(3,4-epoxycyclohexane), dicyclopentadiene diepoxide, ethyleneglycol di(3,4-epoxycyclohexylmethyl) ether, ethylenebis(3,4-epoxycyclohexane carboxylate), epoxidated tetrabenzyl alcohol, lactone-modified 3,4-epoxycyclohexylmethyl-3′,4′-epoxycyclohexane carboxylate, lactone-modified epoxidated tetrahydrobenzyl alcohol, cyclohexene oxide, bisphenol A diglycidyl ether, bisphenol F diglycidyl ether, bisphenol S diglycidyl ether, hydrogenated bisphenol A diglycidyl ether, hydrogenated bisphenol F diglycidyl ether, hydrogenated bisphenol AD diglycidyl ether, brominated bisphenol A diglycidyl ether, brominated bisphenol F diglycidyl ether, brominated bisphenol S diglycidyl ether, epoxynovolak resin, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers; polyglycidyl ethers of polyether polyol obtained by adding one or more alkylene oxides to an aliphatic polyhydric alcohol such as ethylene glycol, propylene glycol and glycerin; diglycidyl esters of aliphatic long chain dibasic acids; monoglycidyl ethers of aliphatic higher alcohol; monoglycidyl ethers of phenol, cresol, butyl phenol or polyether alcohol obtained by adding an alkylene oxide to them; glycidyl esters of higher fatty acids; epoxidated soy bean oil, epoxy butyl stearate, epoxy octyl stearate, epoxidated linseed oil and the like. Examples of oxetane compounds include 3,7-bis(3-oxetanyl)-5-oxa-nonane, 3,3′-(1,3-(2-methylenyl)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycolbis(3-ethyl-3-oxetanylmethyl)ether, dicyclopentenylbis(3-ethyl-3-oxetanylmethyl)ether, triethylene glycolbis(3-ethyl-3-oxetanylmethyl)ether, tetraethylene glycolbis(3-ethyl-3-oxetanyl-methyl)ether, tricyclodecanediyldimethylene(3-ethyl-3-oxetanylmethyl)ether, trimethylolpropanetris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritoltris(3-ethyl-3-oxetanyl-methyl) ether and pentaerythritoltetrakis(3-ethyl-3-oxetanylmethyl)ether, and these can be used singly or in combination of two or more.

Commercially available products of them include Epolight 40E, 100E, 70P, 1500NP, 100MF, 4000, 3002 (these are manufactured by Kyoeisha Kagaku K.K.), Celloxide 2021, 2081, GT301, GT401, Epolead CDM, PB3600, Epofriend A1005, A1010, A1020 (these are manufactured by Daicel Chemical Industries, Ltd.), Denacol 611, 612, 512, 521, 411, 421, 313, 321 (these are manufactured by Nagase Kasei K.K.), Epicoat EP-828EL (Japan Epoxy Resin K.K., trade name), EXA-750 (manufactured by Dainippon Ink & Chemicals, Inc.), and the like.

Radiation Polymerization Initiator (D):

As the initiator (D), those conventionally known can be used. Examples of the initiator include aromatic carbonyl compounds such as benzophenone, benzoin methyl ether, benzoin isopropyl ether, benzyl xanetone, thioxanetone and anthraquinone; acetophenones such as acetophenone, propiophenone, α-hydroxyisobutylphenone, α,α′-dichlor-4-phenoxyacetophenone, 1-hydroxy-1-cyclohexylacetophenone, diacetylacetophenone and acetophenone; organic peroxides such as benzoyl peroxide, t-butyl peroxy-2-ethyl hexanoate, t-butyl hydro peroxide, di-t-butyl diperoxy isophthalate and 3,3′,4,4′-tetra(t-butyl peroxycarbonyl)benzophenone; diphenyl halonium salts such as diphenyl iodo bromide and diphenyl iodo chloride; organic halogen compounds such as carbon tetrabromide, chloroform and iodo-form; heterocyclic or polycyclic compounds such as 3-phenyl-5-isooxazolone and 2,4,6-tris(trichloromethyl)-1,3,5-triazinebenzanthrone; azo compounds such as 2,2′-azo(2,4-dimethylvaleronitrile), 2,2-azobisisobutylonitrile, 1,1′-azobis(cyclohexane-1-carbonitrile) and 2,2′-azobis(2-methylbutyronitrile); iron-allene complexes (see, EU Patent No. 152377); titanocene compounds (see, JP-A No. 63-221110), bisimidazole-based compounds; N-arylglycidyl-based compounds; acrydine-based compounds; combination of aromatic ketone/aromatic amine; peroxyketal (see, JP-A No. 6-321895), and the like. Among the photo-radical polymerization initiator described above, di-t-butyl diperoxy isophthalate, 3,3′,4,4′-tetra(t-butyl peroxycarbonyl)benzophenone, iron-allene complexes and titanocene compounds are preferably used since these have high activity against cross-linking or polymerization.

Examples of trade names include Irgacure 651 (manufactured by Chiba Geigy, trade name, acetophenone-based photo-radical polymerization initiator), Irgacure 184 (manufactured by Chiba Geigy, trade name, acetophenone-based photo-radical polymerization initiator), Irgacure 1850 (manufactured by Chiba Geigy, trade name, acetophenone-based photo-radical polymerization initiator), Irgacure 907 (manufactured by Chiba Geigy, trade name, aminoalkylphenone-based photo-radical polymerization initiator), Irgacure 369 (manufactured by Chiba Geigy, trade name, aminoalkylphenone-based photo-radical polymerization initiator), Lucirin TPO (manufactured by BASF, trade name, 2,4,6-trimethylbenzoyl diphenylphosphine oxide) Kayacure DETXS (manufactured by Nippon Kayaku Co., Ltd., trade name), Irgacure 784 (manufactured by Chiba Geigy, trade name, titanium complex compound), UVI-6950, UVI-6970, UVI-6974, UVI-6990 (these are manufactured by Union Carbide), Adeka Optomer SP-150, SP-151, SP-170, SP-171 (these are manufactured by Asahi Denka Kogyo K.K.), CI-2481, CI-2624, CI-2639, CI-2064 (these are manufactured by Nippon Soda Co., Ltd.), CD-1010, CD-1011, CD-1012 (these are manufactured by Sertomer), DTS-102, DTS-103, NAT-103, NDS-103, TPS-102, TPS-103, MDS-103, MPI-103m BBI-101, BBI-102, BBI-103 (these are manufactured by Midori Kagaku K.K.), Degacure K126 (manufactured by Degussa), and the like.

These initiators (D) can be used singly or in combination of two or more.

If necessary, the above-mentioned photo-polymerization initiator and photo-polymerization initiation aid (sensitizer) can be used in combination. Examples of the photopolymerization initiation aid include 2-dimethylaminoethyl benzoate, N,N′-dimethylaminoethyl methacrylate, isoamyl p-dimethylaminobenzoate and ethyl p-dimethylaminobenzoate.

In the first aspect of the present invention, the compounding ratios of a compound (A), compound (B), compound (C) and initiator (D) are as described below based on 100 wt % of the total amount of these components (reduced by solid).

Compound (A): 10 wt % to 90 wt %, Preferably 30 wt % to 70 wt %

When the compounding ratio of the compound (A) is less than 10 wt %, the number of carboxyl groups contained in the compound (A) decreases in the composition, consequently, developability by an alkali developer lowers and an optical waveguide of excellent performance cannot be formed. Further, film formation also becomes difficult. On the other hand, when over 90 wt %, the ratio of the compound (A) contained in the composition is too high, consequently, for example, if the ratio of the compound (B) is low, photo-curability is lost and an optical waveguide core cannot be formed, and if the ratio of the compound (C) is small, the number of ring-open polymerizable functional groups being cross-linked with carboxyl groups in the compound (A) decreases, the number of cross-linking with the compound (A) becomes poor, resultantly, the optical waveguide formed is poor in reliability.

Compound (B): 1 wt % to 60 wt %, Preferably 5 wt % to 30 wt %

When the compounding ratio of the compound (B) is less than 1 wt %, the concentration of unsaturated groups contained in the composition decreases, consequently, photo-curability is lost and an optical waveguide core cannot be formed. On the other hand, when over 60 wt %, the ratio of the compound (B) occupied in the composition is too large, consequently, the ratio of the compound (A) or compound (C) occupied decreases. For example, when the ratio of the compound (A) decreases, the acid value of the whole composition lowers, developability by alkali development lowers, and an optical waveguide of excellent performance cannot be formed. On the other hand, when the ratio of the compound (C) decreases, the number of ring-open polymerizable functional groups being cross-linked with carboxyl groups in the compound (A) decreases, the number of cross-linking with the compound (A) becomes poor, resultantly, the optical waveguide formed is poor in reliability.

Compound (C): 1 wt % to 60 wt %, Preferably 10 wt % to 40 wt %

When the compounding ratio of the compound (C) is less than 1 wt %, the number of ring-open polymerizable functional groups being cross-linked with carboxyl groups in the compound (A) decreases, the number of cross-linking with the compound (A) becomes poor, resultantly, the optical waveguide formed is poor in reliability. On the other hand, when over 60 wt %, the ratio of the compound (C) occupied in the composition increases, consequently, the ratio of the compound (A) or compound (C) occupied decreases. For example, when the ratio of the compound (A) decreases, the acid value of the whole composition lowers, developability by alkali development lowers, and an optical waveguide of excellent performance cannot be formed. On the other hand, when the ratio of the compound (B) decreases, the number of unsaturated groups contained in the composition decreases, photo-curability is lost, and an optical waveguide core cannot be formed.

Compound (D): 0.01 wt % to 15 wt %, Preferably 0.1 wt % to 7 wt %

When the compounding ratio of the compound (C) is less than 0.01 wt %, curing does not progress sufficiently even if irradiation is performed, and resultantly, an excellent optical waveguide core cannot be formed, exerting a reverse influence on the transferring property of an optical waveguide. On the other hand, when over 15 wt %, radiation does not reach deep portions of the composition, a difference in curing degree occurs between the surface and deep portions of the composition film, an excellent optical waveguide core cannot be formed, exerting a reverse influence on the transferring property of an optical waveguide, additionally, unreacted compound (D) shows gradual progress of a reaction for a long period of time, resultantly, exerting a reverse influence on the stability for a long period of time of an optical waveguide.

Regarding the curable resin composition for optical waveguide according to the first aspect of the present invention, components of the above-mentioned compound (A), compound (B), compound (C) and compound (D) are dissolved or dispersed in an organic solvent and the solution or dispersion can be used as an organic solvent-based resin composition. As the solvent, there are mentioned conventionally known organic solvents, for example, ketones, esters, ethers, cellosolves, aromatic hydrocarbons, alcohols and halogenated hydrocarbons.

Regarding the curable resin composition for optical waveguide according to the first aspect of the present invention, components of the above-mentioned compound (A), compound (B), compound (C) and compound (D) are dispersed in water and the dispersion can be used as an aqueous resin composition.

As the basic compound described above, there can be used, for example, monoethanolamine, diethanolamine, triethylamine, diethylamine, dimethylaminoethanol, cyclohexylaminem ammonia, caustic soda and caustic potash. It is preferable that the use amount of a neutralization agent is in general 0.2 to 1.0 equivalent, particularly 0.3 to 0.8 equivalent per equivalent of a carboxyl group contained in the compound (A).

The curable dry film for forming optical waveguide according to the first aspect of the present invention, a film formed of the above-mentioned curable resin composition for optical waveguide has a softening temperature of 0° C. to 80° C., particularly 10° C. to 80° C.

When the softening temperature of a dry film is less than 0° C., a dry film is, in general, heated in laminating the dry film on a base material, and due to this heating, the dry film is softened, to cause stickiness, resultantly, laminating work becomes remarkably difficult and foaming occurs after laminating. On the other hand, when 80° C. or more, laminating itself cannot be effected and transfer of a dry film is impossible.

The curable dry film for forming optical waveguide according to the first aspect of the present invention can be obtained as described below. The above-mentioned curable resin composition for optical waveguide, namely an organic solvent-based resin composition or an aqueous resin composition is painted and printed on a supporting base material to form a wet film thereof, then, dried at temperatures not causing curing to obtain a dry film. The resulted dry film formed on a supporting base material is peeled from the a supporting base material, then, the peeled single dry film can be used as a material for optical waveguide. It is also possible that a dry film is used as a material for optical waveguide without peeling from a supporting base material, then, unnecessary supporting base material is peeled.

As the supporting base material, for example, any of a polyethylene terephthalate film and films of aramide, captone, polymethylpentene, polyethylene and polypropylene can be used, and particularly, use of a polyethylene terephthalate film is optimal from the standpoint of cost and for obtaining excellent properties as a photosensitive dry film. It is preferable that the thickness of a supporting base material is usually 1 to 100 μm, particularly 10 to 40 μm.

As a method for painting or printing the above-mentioned resin composition on these supporting base material, for example, a roller method, spray method and silk screen method can be conducted. The thickness of a dry film may be appropriately selected depending on an optical waveguide produced, and it is preferable that the thickness is usually 1 μm to 10 mm, particularly 5 μm to 5 mm.

The optical waveguide according to the first aspect of the present invention comprises a lower clad layer, core part and upper clad layer wherein at least one of the lower clad layer, core part and upper clad layer is formed of a cured material of the above-mentioned curable dry film for forming optical waveguide.

In the optical waveguide according to the first aspect of the present invention, when used in at least a part of finally resulting parts (upper and lower clad layer parts, core part), a curable dry film for forming optical waveguide giving a cured film having different refractive index can be obtained by appropriately selecting the kinds and compounding amounts of components, and the like so that a relation between refractive index of the parts satisfied conditions required for an optical waveguide.

In the first aspect of the present invention, an optical waveguide can be formed by using a curable dry film for forming optical waveguide according to the first aspect of the present invention only in a core part and using a conventional radiation curable dry film solution in other clad parts, alternatively, using a curable dry film for forming optical waveguide according to the first aspect of the present invention in a lower layer clad part and a core part, or using a curable dry film for forming optical waveguide according to the first aspect of the present invention in all layers.

An embodiment of an optical waveguide using a dry film according to the first aspect of the present invention and an embodiment of a method for forming an optical waveguide will be specifically illustrated, respectively, referring appropriately to drawings.

(Basic Optical Waveguide Constitution)

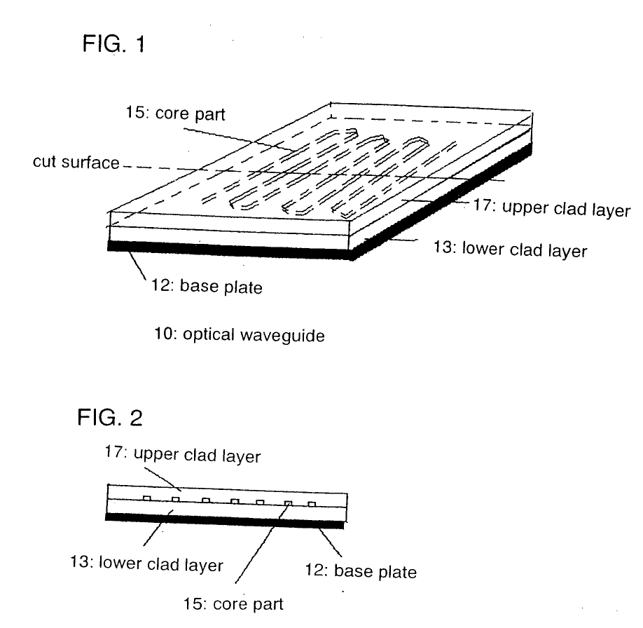

FIG. 1 is a sectional view showing a basic constitution of an optical waveguide constituted by applying a curable dry film for forming optical waveguide. As shown in FIG. 1, an optical waveguide 10 is constituted of a base plate 12, a lower clad layer 13 formed on the surface of this base plate 12, a core part 15 having specific width formed on this lower clad layer 13, and an upper clad layer 17 laminated on this lower clad layer 13 containing the core part 15. The core part 15 is coated, including its side part, by the lower clad layer 13 and the upper clad layer 17 so as to decrease waveguide loss, the core part 15 being totally buried.

(Thickness and Width)

In an optical waveguide having the constitution as described above, the thickness of a lower clad layer, upper clad layer and core part are not particularly limited, and for example, it is preferable that the thickness of a lower clad layer is 1 to 200 μm, the thickness of a core part is 3 to 200 μm and the thickness of an upper clad layer is 1 to 200 μm. Though the width of a core part is not particularly limited, it is, for example, preferable that the width is 1 to 200 μm.

(Refractive Index)

It is necessary that the refractive index of a core part is larger than the refractive indices of a lower and upper clad layers. Therefore, it is preferable that the refractive index of a core part is 1.420 to 1.650 and simultaneously the refractive indices of a lower clad layer and upper clad layer are 1.400 to 1.648, against light of wavelength of 400 to 1600 nm. Further, it is preferable that a difference in refractive index between a core part and a clad layer is 0.1% or more, and particularly, it is preferable that the refractive index of a core part is larger by at least 0.1% than the refractive index of a clad layer.

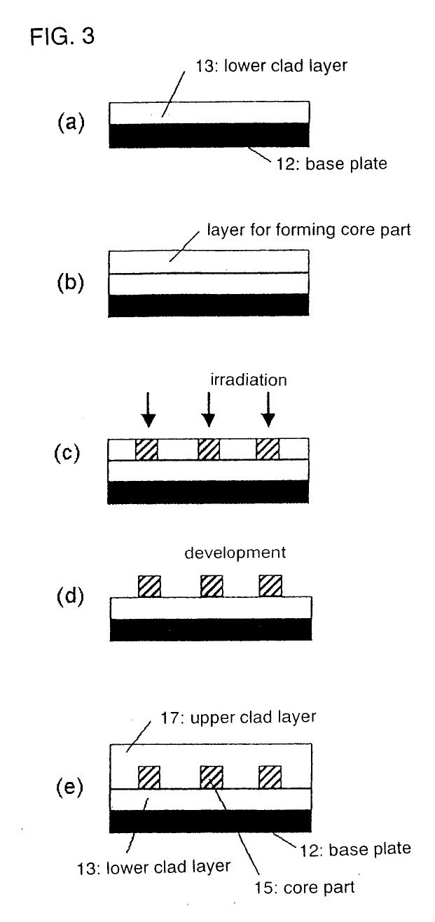

FIG. 2 is a sectional view viewed from the front direction of the section in FIG. 1. An optical waveguide 10 is formed via processes as shown in FIG. 3. Namely, it is preferable that curable dry films for forming optical waveguide for forming any of a lower clad layer 13, core part 15 and upper clad layer 17 or all of them are sequentially transferred on a base material, then, cured by radiation. In the following forming example, an explanation will be made hypothesizing that a lower clad layer and a core part are made of a dry film, and an upper clad layer is formed of a curable dry film for forming optical waveguide.

(Preparation of Base Plate)

First, a base plate 12 having a flat surface is prepared. The kind of this base plate 12 is not particularly restricted, and for example, a silicon base plate and glass base plate can be used.

(Process of Forming Lower Clad Layer)

This is a process of forming a lower clad layer 13 on the surface of a base plate 12 prepared. Specifically, a dry film is transferred onto the surface of a base plate 12 by applying suitable heat and pressure using a press means such as a normal pressure heat roll press method, vacuum heat roll press method and vacuum heat press method while removing a cover film so that a base film faces up, as shown in FIG. 3(a). This film for lower layer can be irradiated with radiation to be cured, forming the lower clad layer 13. In the process of forming the lower clad layer 13, it is preferable that the whole surface of a film is irradiated with radiation, to cure the whole body.

The irradiation amount of radiation in forming a lower clad layer is also not particularly limited, however, it is preferable that a radiation having a wavelength of 200 to 440 nm and an illumination of 1 to 500 mW/cm² is irradiated so that the illumination amount is 10 to 5000 mJ/cm², performing exposure. Here as the radiations irradiated, visible light, ultraviolet ray, infrared ray, X ray, α ray, β ray and γ ray can be used, and particularly, ultraviolet ray is preferable. As the irradiation apparatus of a radiation (ultraviolet ray), for example, a high pressure mercury lamp, low pressure mercury lamp, metal halide lamp and excimer lamp are preferably used. After exposure, it is preferable to further conduct a heating treatment (hereinafter, referred to as post bake) so that the whole surface of a film is sufficiently cure. Though conditions for this heating change depending on the compounding composition of a radiation curable resin dry film and the kind of an additive, it may be advantageous that heating is conducted usually at 30 to 400° C., preferably 50 to 300° C. for, for example, 5 minutes to 72 hours. The irradiation amount and kind of a radiation and the irradiation apparatus of a radiation (ultraviolet ray), and the like, in a process of forming a lower clad layer are applied also in a process of forming a core part and a process of forming an upper clad layer desc [symbol] , [symbol] diation curable resin dry film is transferred onto the surface of a lower clad layer 13 by applying suitable heat and pressure using a press means such as a normal pressure heat roll press method, vacuum heat roll press method and vacuum heat press method while removing a cover film so that a base film faces up, in the same manner as for formation of a lower clad layer, as shown in FIG. 3(b). This core part formation layer can be cured by irradiation with a radiation so as to form a core part (FIG. 3(c)), then, un-cured parts can be removed according to conditions and a developer described later, to form a core part 15 on the surface of a lower clad layer 13 (FIG. 3(d)).

For easily obtaining stability (developer swelling resistance) of a pattern shape after development or further enhancing stability (developer swelling resistance), in a stage of pattern-wise curing of a part to be a core part, a heating treatment may also be conducted on a resin layer for a core part, or both resin layers for a lower clad layer and a core part. The heating treatment can be conducted, for example, at 60 to 10° C., preferably 65 to 85° C. for 1 to 10 minutes, preferably 1 to 3 minutes, using a hot plate and the like. By adding this heating treatment, it becomes possible to form a core shape having high contrast further with good precision and excellent shape stability on a part from which a solvent is to be removed in development, using a developer of an organic base aqueous solution like a diethanolamine aqueous solution. Therefore, by conducting this heating treatment, selection width for developers can be enlarged, and selection of strong developers enabling a faster process treatment and developers containing substantially no metal ion is also possible. For example, since metal ions such as a sodium ion exert an influence on a semiconductor base plate, when an optical waveguide is formed on a semiconductor base plate, developers such as an organic base aqueous solution containing no metal ion such as a sodium ion are preferable, and by conducting the above-mentioned heating treatment, a development treatment of higher precision at such a metal ion free condition is possible.

Next, after formation of a core part 15, a dry film for forming an upper clad layer 17 is transferred and pre-baked to form an upper clad layer 17 in the same manner as described above on this core part 15 and a lower clad layer 13. Thereafter, by effecting irradiation with a radiation on the whole surface of the upper clad layer 17, an optical waveguide according to the first aspect of the present invention can be produced.

As the developer, there can be used alkali aqueous solutions composed of an organic solvent and alkalis such as sodium hydroxide, potassium hydroxide, sodium carbonate, sodium silicate, sodium metasilicate, ammonia, ethylamine, n-propylamine, diethylamine, di-n-propylamine, triethylamine, methyldiethylamine, N-methylpyrrolidone, dimethylethanolamine, triethanolamine, tetramethylammonium hydroxide, tetraethylammonium hydroxide, choline, pyrrole, piperidine, 1,8-diazabicyclo[5.4.0]-7-undecene and 1,5-diazabicyclo[4.3.0]-5-nonane. When an alkali aqueous solution is used, it is preferable that its concentration is usually 0.05 to 25% by weight, preferably 0.1 to 3.0 wt %. It is also preferable that a water-soluble organic solvent such as methanol and ethanol, and a surfactant and the like are added in suitable amounts to such an alkali aqueous solution to give a developer to be used.

The development time is usually 30 to 600 seconds, and as the development method, there can be adopted known methods such as a liquid dosing method, dipping method and shower development method. When an organic solvent is used as the developer, it is air-dried, and when an alkali aqueous solution is used, washing with running water is conducted for 30 to 90 seconds, and it is air-dried with compressed air, compressed nitrogen and the like to remove water on its surface, thus, a film in the form of pattern is formed. Then, for further curing a patterning part, a post bake treatment is conducted, for example, at temperatures of 30 to 400° C. for 5 to 600 minutes by a heating apparatus such as a hot plate and oven, to form a core part cured.

In the first aspect of the present invention, by using a curable dry film for forming optical waveguide according to the first aspect of the present invention particularly as a clad layer of a thin film for upper layer, a curable resin composition for forming optical waveguide fluidized by heating flows to a dent part at a convex part of a core part and is filled therein to form a clad layer, therefore, a clad layer is formed without generating a gap between the clad layer and core layer.

Next, by curing this film for upper layer by irradiation with a radiation, an upper clad layer 17 can be formed s shown in FIG. 1.

The upper clad layer obtained by irradiation with a radiation is preferably further subjected to the above-mentioned post bake, if necessary. By conducting post bake, an upper clad layer excellent in hardness and heat resistance can be obtained.

Next, preferable embodiments of the second aspect of the present invention will be described.

In the method for forming an optical waveguide according to the second aspect of the present invention, a glass transition temperature in laminating on a core part (II) of a dry film for forming an upper clad layer (III) is lower by 10° C. or more than the glass transition temperature of a cured resin forming the core part (II), and the laminating temperature of a dry film is higher by 10° C. or more than the glass transition temperature of a dry film. Further, the upper limit of the laminating temperature of a dry film for forming the upper clad layer (III) is preferably about 140° C. It is desirable that the glass transition temperature of a dry film for a core part and the glass transition temperature of a dry film for an upper clad layer are selected in a range of −40° C. to 140° C., preferably −20° C. to 100° C. so as to satisfy the above-mentioned relation. Further, the softening temperature of a dry film for forming an upper clad layer under no-curing (before exposure) is preferably 0 to 80° C. for further enhancing coatability on a core part.

The method for forming an optical waveguide according to the second aspect of the present invention is not particularly restricted providing its satisfies the above-mentioned conditions, and particularly, the following formation method is preferable.
(1) a dry film having a thermosetting resin layer for lower clad layer is thermally transferred to form a lower clad thermosetting resin layer,
(2) curing a thermosetting resin layer for lower clad layer by heating to form a lower clad layer (I),
(3) then, a dry film having an active energy ray curable resin layer for core part is thermally transferred to the surface of the lower clad layer (I) to form the active energy ray curable resin layer for core part,
(4) then, the surface of the active energy ray curable resin layer for core part is irradiated pattern-wise with an active energy ray to be cured so as to form a core part.
(5) then, un-cured layers (parts other than core part) are removed by a development treatment to form a core part (II),
(6) a dry film composed of a thermosetting resin composition for upper clad layer having a glass transition temperature lower by 10° C. or more than the glass transition temperature of a cured resin of the resulted core part (II) is used,
(7) this dry film is laminated on the surface of the core part (II) and lower clad layer (I) while heating and pressing at temperatures higher by 10° C. or more than the glass transition temperature of a dry film for an upper clad layer, to form an active energy ray curable resin layer for upper clad layer,
(8) then, the above-mentioned thermosetting resin layer for upper clad layer is cured by heat to form an optical waveguide.

For easily obtaining stability (developer swelling resistance) of a pattern shape after development or further enhancing stability (developer swelling resistance), in a stage of pattern-wise curing of a part to be a core part by the above-mentioned process (4), a heating treatment may also be conducted on a resin layer for a core part, or both resin layers for a lower clad layer and a core part. Specific conditions thereof are the same as the conditions for the processes in FIG. 3 in the description of the first aspect of the present invention. The material of a base plate is also the same as in the first aspect of the present invention.

The above-mentioned processes (1) to (8) can be illustrated further in detail referring to FIG. 3. The order of (a) to (e) in FIG. 3 does not necessarily correspond to the above-mentioned processes (1) to (8).

FIG. 3(a) is a sectional view showing a lower clad layer 13 laminated on the surface of a base plate 12. As the method for forming the lower clad layer 13, a method of laminating a dry film to be a thermosetting resin layer for lower clad layer on a base plate can be used. As this dry film, there can be specifically used those obtained, for example, by dissolving or dispersing a conventionally known thermosetting resin for clad layer in an organic solvent or water to give a resin composition, painting or printing the resin composition on a supporting base material to form a wet film, then, drying the film at temperatures not causing curing to form a dry film composed of a thermosetting resin composition for lower clad layer on the surface of a supporting base material.

If necessary, a cover film may also be laminated on the surface of a dry film for lower clad layer situated on the opposite side of the supporting base material.

A supporting base material can be peeled from a dry film and the dry film can be used as a material for clad layer. It is also possible that, without peeling a supporting base material from a dry film, the composite is used as a material for clad layer, then, the unnecessary supporting base material is peeled.

Also in the case of forming a core part and an upper clad layer, it may likewise be permissible that a supporting base material is peeled from a dry film and the dry film is used as a material for a core part or upper clad layer. After used as a material for a core part or upper clad layer, the unnecessary supporting base material may be peeled from the upper clad layer.

When a dry film capable of forming a core part is previously formed on a supporting base material using that which can be utilized as a lower clad as a supporting base material, a supporting base material can be used itself as a lower clad without peeling a dry film from the supporting base material. Further, it is also possible that a dry film capable of forming a core part is previously formed on a supporting base material using that which can be utilized as an upper clad, a core part is formed, then, this is connected on a lower clad, to utilize the supporting base material as an upper clad.

Specific examples of the supporting base material are the same as for the first aspect of the present invention. As the cover film, the same material as for a supporting base material may be used, and a polyethylene film is preferable from the standpoint of easiness of peeling from a dry film and of cost. The thickness of a cover film is usually from 1 to 100 μm, particularly from 10 to 40 μm.

Painting and printing of a resin composition on these supporting base materials can be conducted, for example, by a roller method, spray method and silk screen method.

The thickness of a lower clad layer may be appropriately selected depending on an optical waveguide produced, and is preferably in the range usually of 1 μm to 10 mm, particularly of 5 μm to 5 mm.

In the process of forming a lower clad layer, specifically, the surface of a base material 12 and a thermosetting resin layer for lower clad layer are allowed to surface-contact with each other, suitable heat and pressure are applied on the surface of a supporting base material by a press means such as a normal pressure heat roll press method, vacuum heat roll press method and vacuum heat press method, and a dry film is transferred on a base plate while peeling the supporting base material from the thermosetting resin layer for lower clad layer, thus, the thermosetting resin layer for lower clad layer can be formed on the surface of the base plate 12.

The thermosetting resin layer for lower clad layer formed is cured by heat to form a lower clad layer (I) (13 in FIG. 3(a) represents a cured layer). When a composition comprising a thermosetting resin such as a carboxyl group-containing resin (for example, carboxyl group-containing urethane resin, etc.), epoxy group-containing resin (for example, epoxy resin, etc.) and the like, and additionally, further comprising a light latent catalyst as a curing catalyst, or a composition comprising a compound having an active energy ray-curable reactive group (vinyl group, acryloyl group, methacryloyl group and the like) and an optical polymerization initiator together is used for formation of a thermosetting resin layer for lower clad layer, it can be subjected to post bake after irradiation with an active energy ray.

The radiation irradiated on a lower clad layer is the same as in the first aspect of the present invention.

Though post bake conditions vary depending on the kind of a thermosetting resin, and the like, it is usually advantageous that post bake is conducted at 30 to 400° C., preferably 140 to 300° C. for 5 minutes to 72 hours.

As the thermosetting resin for lower clad layer used for forming a lower clad layer (I), conventionally known resins can be used, and particularly, it is preferable to use a resin of substantially the same composition as for a thermosetting resin for upper clad layer described below used for forming an upper clad layer (III).

The core part (II) can be formed by thermally transferring a dry film composed of an active energy ray-curable resin composition for core part supported on a supporting base material onto the surface of a lower clad layer (I) formed, then, irradiating the surface of the active energy ray-curable resin composition for core part with an active energy ray to cure the composition so as to form a core part, then, removing un-cured layers (parts other than a part to be a core part) by a development treatment. As the supporting base material, the same materials as described for a dry film to be a thermosetting resin layer for lower clad layer described above can be used.

If necessary, a cover film may be laminated like the case of a thermosetting resin layer for lower clad layer. Specifically, for example, a conventionally known active energy ray-curable resin for core part can be dissolved or dispersed in an organic solvent or water to give a resin composition which is painted or printed on the above-mentioned supporting base material for form a wet film which is then dried at temperatures not causing curing to obtain a dry film having the active energy ray-curable resin layer for core part laminated on the surface of the supporting base material. It is also possible to obtain a dry film having physical properties for forming a core part, using components capable of forming a dry film for forming an upper clad layer described later.

A dry film having an active energy ray-curable resin layer for core part is transferred or laminated on the surface of a lower clad layer 13, in the same manner as for formation of a lower clad layer described above, while removing a supporting base material (in the case of presence of supporting base material) so that a dry film can contact the surface of the lower clad layer 13, using a press means such as a normal pressure heat roll press method, vacuum heat roll press method and vacuum heat press method, while applying suitable heat and pressure.

This active energy ray-curable resin layer for forming core part is irradiated with light via a photomask, or irradiated with light directly while scanning depending on pattern to cure the layer, then, un-cured parts are removed by developer and conditions described below, thus, a core part (II) 15 can be formed on the surface of a lower clad layer (I) 13.

Specific examples of the developer are the same as for the first aspect of the present invention. When an alkali aqueous solution is used, it is preferable that its concentration is usually 0.05 to 25 wt %, preferably 0.1 to 3.0 wt % It is preferable that the temperature is usually 5° C. to 60° C., preferably 10° C. to 40° C. It is also preferable that an aqueous organic solvent such as methanol and ethanol, and a surfactant and the like are added in suitable amounts to such an alkali aqueous solution to give a developer to be used.

The development time is usually 30 to 600 seconds, and as the development method, there can be adopted known methods such as a liquid dosing method, dipping method and shower development method. When an organic solvent is used as the developer, it is air-dried, and when an alkali aqueous solution is used, washing with running water is conducted, for example, for 30 to 90 seconds, and it is air-dried with compressed air, compressed nitrogen and the like to remove water on its surface, thus, a core part is formed.

When a thermosetting resin is used together as an active energy ray-curable resin for forming core part, a core part may be thermally cured like the above-mentioned post bake.

The thickness of a core part is preferably 3 to 200 μm. Though the width of a core part is also not particularly restricted, it is preferably in the range, for example, of 1 to 200 μm.

A dry film composed of a thermosetting resin layer for upper clad layer having a glass transition temperature lower by 10° C. or more than the glass transition temperature of a cured resin of a core part (II) is laminated on the surface of the core part (II) and lower clad layer (I) while heating and pressing at temperatures higher by 10° C. or more than the glass transition temperature of this dry film, to form a thermosetting resin layer for upper clad layer, then, the thermosetting resin layer for upper clad layer is cured by heat to form an upper clad layer (III), obtaining an optical waveguide.

For example, that having a glass transition temperature lower by 10° C. or more than the glass transition temperature of a cured resin forming a core part is selected among conventionally known resins for forming upper clad layer and dissolved or dispersed in an organic solvent or water to obtain a resin composition which is painted or printed on the surface of a supporting base material to form a wet film thereon, then, the wet film is dried at temperatures not causing curing to form a dry film on the surface of the supporting base material, and this can be used as a dry film for forming a thermosetting resin layer for upper clad layer. The method for laminating a resin layer for forming upper clad layer on the surface of a supporting base material is the same as that for laminating a thermosetting resin layer for lower clad layer and resin layer for core part described above.

When a dry film held on a supporting base material is used, the surface of a core part (II) and lower clad layer (I) and a dry film held on a supporting base material for an upper clad layer are allowed to surface-contact with each other, suitable heat and pressure are applied on the surface of a supporting base material by a press means such as a normal pressure heat roll press method, vacuum heat roll press method and vacuum heat press method, at temperatures higher by 10° C. or more than the glass transition temperature of this dry film, and the dry film is transferred on a base plate while peeling the supporting base material from the dry film, thus, a thermosetting resin layer for upper clad layer can be formed on the surface of the core part (II) and lower clad layer (I).

The thermosetting resin layer for upper clad layer formed is cured by heat to form an upper clad layer (III) (17 in FIG. 3(e) represents a cured layer).

As the composition for forming a thermosetting resin layer for upper clad layer, conventionally known thermosetting resin compositions described below, for example, can be used without specific limitation, and particularly, thermosetting resin compositions containing a heat latent catalyst and/or light latent catalyst are preferably used.

As the thermosetting resin composition, for example, there can be used those having in combination a heat reactive functional group in a base resin and a functional group reacting with the above-mentioned functional group by heat and those having a group of self cross-linking type such as an N-methylol group and N-alkoxy-methylol group. Examples of the combination of heat reactive functional groups described above include combinations of a carboxyl group and epoxy group (oxylane group), carboxylic anhydride and epoxy group (oxylane group), amino group and epoxy group (oxylane group), carboxyl group and hydroxyl group, carboxylic anhydride and hydroxyl group, isocyanate group and hydroxyl group, isocyanate group and amino group, and the like, and additionally, any of curing systems described in literature: “Kakyo system no kaihatsu to oyo gijutsu (development of cross-linking system and application technology)” (Gijutsu Joho kyokai publication) may be permissible.

In the second aspect of the present invention, acid curing type epoxy resin compositions having a combination of a carboxylic acid and an epoxy group (oxylane group) capable of being cured by any curing catalyst among basic catalysts and acidic catalysts are recommendable. Examples of such preferable acid curing type epoxy resin compositions include compositions composed of a carboxyl group-containing acrylic resin and an epoxy resin having at least two or more glycidyl groups in the molecule, and resin compositions composed of a carboxyl group-containing urethane resin and an epoxy resin having at least two or more glycidyl groups in the molecule.

As the above-mentioned acid curing type epoxy resin composition, those comprising, as essential components, (A) a carboxyl group-containing urethane compound and (C) a compound containing two or more ring-opening polymerizable functional groups in the molecule, and if necessary, (B) a polymerizable unsaturated compound, and (D) a radiation polymerization initiator, are particularly preferably used. Specific examples of these components (A) to (D) are the same as for the first aspect of the present invention.

In the second aspect of the present invention, the compounding ratios of a compound (A), compound (B), compound (C) and initiator (D) are as described below based on 100 wt % of the total amount of these components (reduced by solid).

Compound (A): 10 wt % to 90 wt %, Preferably 20 wt % to 80 wt %, Further Preferably 40 wt % to 70 wt %

When the compounding ratio of the compound (A) is less than 10 wt %, the number of carboxyl groups contained in the compound (A) decreases in the composition, consequently, developability by an alkali developer lowers and an optical waveguide of excellent performance cannot be formed. Further, film formation also becomes difficult. On the other hand, when over 90 wt %, the ratio of the compound (A) contained in the composition is too high, consequently, for example, if the ratio of the compound (B) is low, photo-curability is lost and an optical waveguide core cannot be formed, and if the ratio of the compound (C) is small, the number of ring-open polymerizable functional groups being cross-linked with carboxyl groups in the compound (A) decreases, the number of cross-linking with the compound (A) becomes poor, resultantly, the optical waveguide formed is poor in reliability.

Compound (C): 10 wt % to 90 wt %, Preferably 20 wt % to 80 wt %

When the compounding ratio of the compound (C) is less than 10 wt %, the number of ring-open polymerizable functional groups being cross-linked with carboxyl groups in the compound (A) decreases, the number of cross-linking with the compound (A) becomes poor, resultantly, the optical waveguide formed is poor in reliability. On the other hand, when over 90 wt %, the ratio of the compound (C) occupied in the composition increases too much, consequently, the acid value of the whole composition lowers, developability by alkali development lowers, and an optical waveguide of excellent performance cannot be formed.

Compound (B): 0 wt % to 60 wt %, Preferably 1 wt % to 40 wt %

By inclusion of the compound (B), photo-curability can be imparted to a composition and an optical waveguide of excellent performance can be formed.

Compound (D): 0 wt % to 15 wt %, Preferably 0.1 wt % to 7 wt %

By inclusion of the compound (D), curing by irradiation with a radiation can be sufficiently conducted, and an optical waveguide excellent in a transmitting property can be formed.

In the second aspect of the present invention, it is particularly preferable to compound a heat latent catalyst in the above-mentioned thermosetting resin composition.

The above-mentioned heat latent catalyst is a compound which does not function substantially as a catalyst at temperatures around room temperature (about 25° C.), but functions itself as a catalyst or generates a chemical species acting as a catalyst at high temperatures of usually from 70° C. to 210° C.

As the heat latent catalyst, strong acid onium salts, strong acid esters and the like are listed. The strong acid onium salt includes quaternary ammonium salts, quaternary phosphonium salts, quaternary arsonium salts, tertiary sulfonium salts, tertiary selenonium salts, secondary iodonium salts, diazonium salts and the like. The strong acid ester includes esters of sulfuric acid, sulfonic acid, phosphoric acid, phosphinic acid, phosphonic acid, and the like.

Instead of the heat latent catalysts, light latent catalysts may be used. The light latent catalyst includes light base generators and light acid generators.

The light base generator is a compound generating a base by irradiation with an active energy ray, and this generated base is used as a catalyst to cure a resin composition, and conventionally known generators can be used. Examples thereof include cobalt amine complexes, ketone oxime esters, carbamates such as o-nitrobezyl carbamates, formamides and the like. Specific examples thereof include carbamates such as NBC-101 (CAS. No. [119137-03-0]) manufactured by Midori Kagaku K.K., further, triarylsulfonium salts such as TPS-OH (CAS. No. [58621-56-0]) manufactured by Midori Kagaku K.K.

On the other hand, the light acid generators is a compound generating an acid by irradiation with an active energy ray, and this generated acid is used as a catalyst to cure a resin composition, and conventionally known generators can be used. Examples thereof include onium salts such as sulfonium salts, ammonium salts, phosphonium salts, iodonium salts and selenium salts, iron-allene complexes, ruthenium-allene complexes, silanol-metal chelate complexes, triazine compounds, diazidenaphthoquinone compounds, sulfonates, sulfonic imide esters and halogen-based compounds. Further, light acid generators described in JP-A No. 7-146552 are also listed, in addition to the above-mentioned compounds.

Regarding the thermosetting resin composition, components described above can be dissolved or dispersed in an organic solvent to obtain an organic solvent-based resin composition to be used. Specific examples of the organic solvent are the same as for the first aspect of the present invention.

Regarding the thermosetting resin composition, a neutralized substance obtained by neutralizing the above-mentioned compound (A) with a basic compound, a compound (C) and if necessary, other components can be dissolved in water to obtain an aqueous resin composition to be used. Specific examples and use amount of the basic compound are the same as for the first aspect of the present invention.

In the second aspect of the present invention, the dissociation temperature of a heat latent catalyst or light latent catalyst is a value measured by using a differential scanning calorimeter (DSC).

Here, the irradiation amount of a radiation in irradiating an upper clad layer, and the kind of a radiation to be irradiated are the same as for irradiation with the above-mentioned active energy ray.

Conditions for this post bake vary depending on the kind of a thermosetting resin, and the like, and it may be advantageous to effect post bake at 30 to 400° C., preferably 140 to 300° C. for, for example, 5 minutes to 72 hours.

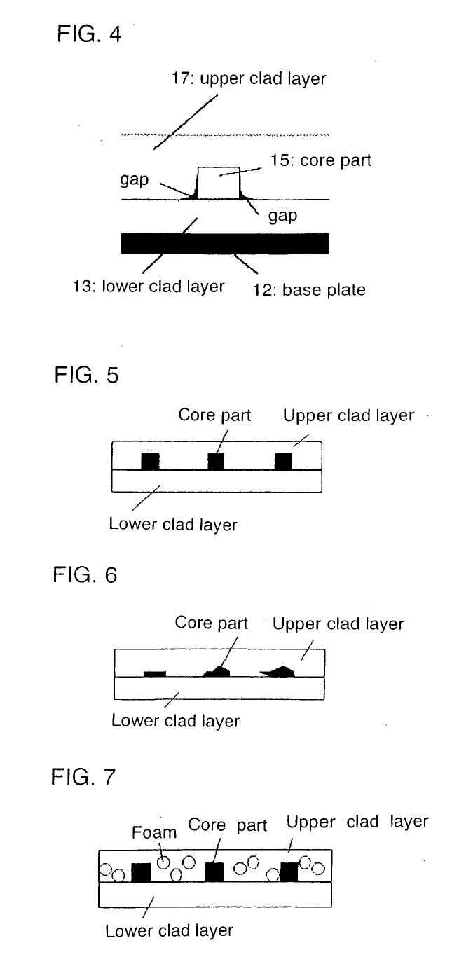

In the second aspect of the present invention, when the glass transition temperature of a thermosetting resin composition for upper clad layer made into a dry film is lower by less than 10° C. than the glass transition temperature of a cure resin of a core part, a dent part at a convex part of a core part cannot be filled with a dry film made of an active energy ray-curable resin for upper clad layer, and a gap is generated in an interlaminar space between a core layer and a clad layer (see FIG. 4), or a core is deformed by pressure in laminating (see FIG. 6), and an optical waveguide having a sufficient transmission property cannot be obtained.

When the temperature of laminating a dry film for forming upper clad layer onto the surface of a lower clad layer having a core part formed is lower by less than 10° C. than the glass transition temperature of a dry film for upper clad layer, a dent part at a convex part of a core part cannot be filled with an active energy ray-curable resin layer for upper clad layer, therefore, a gap is generated in an interlaminar space between a core layer and a clad layer, and an optical waveguide having a sufficient transmission property cannot be obtained (see FIG. 4).

It is necessary that the refractive index of a core part is larger than both the refractive index of a lower clad layer and the refractive index of an upper clad layer. Therefore, it is preferable that the refractive index of a core part is in the range of 1.420 to 1.650, and the refractive indices of a lower clad layer and an upper clad layer are respectively within the range of 1.400 to 1.648, against light having a wavelength of 400 to 1600 nm. It is preferable that a difference in refractive index between a core part and a clad layer is 0.1% or more, and particularly, it is preferable that the refractive index of a core part is larger by at least 1.5% than the refractive index of a clad layer.

In the method according to the second aspect of the present invention, the glass transition temperature is a value measured by using a differential scanning calorimeter (DSC). The refractive index is a value measured with light of a wavelength of 850 nm using an Abbe refractometer.

The first aspect of the present invention will be illustrated further in detail by the following examples, but the scope of the invention is not limited to these examples.

### PREPARATION EXAMPLE OF CURABLE RESIN COMPOSITION FOR OPTICAL WAVEGUIDE

### SYNTHESIS EXAMPLE OF CARBOXYL GROUP-CONTAINING URETHANE COMPOUND (A-1)

A methyl ethyl ketone solvent was charged in suitable amount in a flask equipped with a reflux equipment, and 39.4 g of dimethylolbutanoic acid having two hydroxyl groups and one carboxyl group in one molecule, 7.6 g of 1,6-hexanediol having two hydroxyl groups in one molecule, 6.7 g of neopentyl glycol having two hydroxyl groups in one molecule, 46.3 g of toluene diisocyanate having two isocyanate groups in the molecule, and 500 ppm of dibutyltin dilaurate as a reaction catalyst were added therein, and the mixture was heated up to 75° C. while stirring. After heating up to 75° C., they were reacted under stir for 12 hours while maintaining this temperature to obtain a carboxyl group-containing urethane compound A-1.

### SYNTHESIS EXAMPLE OF CARBOXYL GROUP-CONTAINING URETHANE COMPOUND (A-2)

A methyl ethyl ketone solvent was charged in suitable amount in a flask equipped with a reflux equipment, and 35.7 g of dimethylolbutanoic acid having two hydroxyl groups and one carboxyl group in one molecule, 13.8 g of 1,6-hexanediol having two hydroxyl groups in one molecule, 50.5 g of trimethylhexamethylene diisocyanate having two isocyanate groups in the molecule, and 500 ppm of dibutyltin dilaurate as a reaction catalyst were added therein, and the mixture was heated up to 75° C. while stirring. After heating up to 75° C., they were reacted under stir for 12 hours while maintaining this temperature to obtain a carboxyl group-containing urethane compound A-2.

### SYNTHESIS EXAMPLE OF CARBOXYL GROUP-CONTAINING URETHANE COMPOUND (A-3) (FOR COMPARATIVE EXAMPLE)

A methyl ethyl ketone solvent was charged in suitable amount in a flask equipped with a reflux equipment, and 39.8 g of dimethylolbutanoic acid having two hydroxyl groups and one carboxyl group in one molecule, 13.5 g of neopentyl glycol having two hydroxyl groups in one molecule, 46.7 g of trimethylhexamethylene diisocyanate having two isocyanate groups in the molecule, and 500 ppm of dibutyltin dilaurate as a reaction catalyst were added therein, and the mixture was heated up to 75° C. while stirring. After heating up to 75° C., they were reacted under stir for 12 hours while maintaining this temperature to obtain a carboxyl group-containing urethane compound A-3.

### SYNTHESIS EXAMPLE OF RADICAL POLYMERIZABLE COMPOUND (A-4) (COMPARATIVE EXAMPLE)

A flask equipped with a dry ice/methanol reflux equipment was purged with nitrogen, then, 0.5 g of 2,2-azobisdimethylvaleronitrile as a polymerization initiator and 54.3 g of ethyl lactate as an organic solvent were charged, and stirred until dissolution of the polymerization initiator. Subsequently, 4.5 g of methacrylic acid, 9.0 g of dicyclopentanyl methacrylate, 20.4 g of methyl methacrylate and 11.3 g of n-butyl acrylate were charged, then, stirring thereof was gently initiated. Then, the temperature of the solution was raised up to 80° C., and polymerization was conducted at this temperature for 4 hours. Then, the reaction product was dropped into a large amount of hexane to coagulate the reaction product. Further, this coagulated product was dissolved again in tetrahydrofuran of the same weight as this product, and coagulated again with a large amount of hexane. This re-dissolution and coagulation operation was conducted three times in total, then, the resulted coagulated product was vacuum-dried at 40° C. for 48 hours, to obtain a radical polymerizable compound A-4.

### SYNTHESIS EXAMPLE OF ETHYLENICALLY UNSATURATED GROUP-CONTAINING CARBOXYLIC ACID RESIN (A-5) (FOR COMPARATIVE EXAMPLE)

175 g of phenol novolak resin (manufactured by Nippon Kayaku Co., Ltd., LRE-305), 317.7 g of polyethylene glycol diacrylate (manufactured by Nippon Kayaku Co., Ltd., KAYARAD PEG400DA), 50.4 g of acrylic acid, 40.2 g of dimethylolpropionic acid and 0.5 g of p-methoxyphenol were charged and dissolved and mixed at 80° C., then, 1.6 g of triphenyl phosphine was charged, and reacted at 95° C. for about 32 hours, and after the acid value of the reaction liquid reached 1.0 or lower, the reaction was terminated, then, 50 g of succinic anhydride was charged, and reacted at 90° C. for about 10 hours, after anhydride groups in the reaction liquid disappeared, the reaction was terminated, to obtain a product A-7 containing polyethylene glycol diacrylate as a diluent in an amount of 50 wt %, excluding diluent, and having an acid value of 88.

Preparation of Curable Resin Composition for Optical Waveguide Z-1:

61.5 parts by weight of the above-mentioned carboxyl group-containing urethane compound A-1 as the compound (A), 12.3 parts by weight of Aronix M-8100 (manufactured by Toagosei Co., Ltd., trade name) as the compound (B), 6.1 parts by weight of trimethylolpropane triacrylate, 19.5 parts by weight of Epicoat EP-828EL (manufactured by Japan Epoxy Resin K.K., trade name) as the compound (C), and 0.6 parts by weight of Irgacure 907 (manufactured by Chiba Specialty Chemicals) as the compound (D) were added and mixed in a methyl ethyl ketone solvent, to obtain a uniform solution of composition Z-1.

Preparation of Curable Resin Composition for Optical Waveguide Z-2:

59.4 parts by weight of the above-mentioned carboxyl group-containing urethane compound A-2 as the compound (A), 17.8 parts by weight of trimethylolpropane triacrylate as the compound (B), 21.6 parts by weight of EXA-750 (manufactured by Dainippon Ink & Chemicals. Inc.) as the compound (C), 0.6 parts by weight of Irgacure 907 (manufactured by Chiba Specialty Chemicals) as the compound (D) and 0.6 parts by weight of N-(trifluoromethylsulfonyloxy)-1,8-naphthalenedicarboxyimide were added and mixed in a methyl ethyl ketone solvent, to obtain a uniform solution.

Preparation of Curable Resin Composition for Optical Waveguide Z-3 (for Comparative Example 1-1):

61.5 parts by weight of the above-mentioned carboxyl group-containing urethane compound A-3 as the compound (A), 12.3 parts by weight of Aronix M-8100 (manufactured by Toagosei Co., Ltd., trade name) as the compound (B), 6.1 parts by weight of trimethylolpropane triacrylate, 19.5 parts by weight of Epicoat EP-828EL (manufactured by Japan Epoxy Resin K.K., trade name) as the compound (C), and 0.6 parts by weight of Irgacure 907 (manufactured by Chiba Specialty Chemicals, trade name) as the compound (D) were added and mixed in a methyl ethyl ketone solvent, to obtain a uniform solution.

Preparation of Curable Resin Composition for Optical Waveguide Z-4 (for Comparative Example 1-2):

32.0 parts by weight of the above-mentioned radical polymerizable compound A-4, 10.0 parts by weight of Aronix M-8100 (manufactured by Toagosei Co., Ltd., trade name) as the compound (B), 6.5 parts by weight of trimethylolpropane triacrylate, 3.0 parts by weight of Irgacure 907 (manufactured by Chiba Specialty Chemicals, trade name) as the compound (D) and 48.5 parts by weight of ethyl lactate were added and mixed, to obtain a uniform solution.

Preparation of Curable Resin Composition for Optical Waveguide Z-5 (for Comparative Example 1-3):

68 parts by weight of the above-mentioned ethylenically unsaturated group-containing carboxylic acid resin A-5, 29 parts by weight of KAYARAD R-604 (manufactured by Nippon Kayaku Co., Ltd., trade name) as a polymerizable compound and 3.0 parts by weight of Irgacure 907 (manufactured by Chiba Specialty Chemicals, trade name) as a photo-polymerization initiator were added and mixed, to obtain a uniform solution.

The above-mentioned resin compositions for optical waveguide are summarized in Table 1.

### EXAMPLES 1-1

Forming of Optical Waveguide:

Formation of Lower Clad Layer:

The curable resin composition for optical waveguide Z-2 was applied on the surface of a silicon base plate by a spin coat method, and dried at 80° C. for 30 minutes. Thereafter, the composition was irradiated with ultraviolet ray having a wavelength of 365 nm and an illumination of 200 mW/cm² for 5 seconds, then, heat-cured at 150° C. for 30 minutes, to obtain a lower clad layer having a thickness of 40 μm.

Formation of Core Part (1):

Next, the curable resin composition for optical waveguide Z-1 was applied on a lower clad layer by a spin coat method, and dried at 80° C. for 30 minutes. Then, the composition was irradiated with ultraviolet ray having a wavelength of 365 nm and an illumination of 10 mW/cm² for 100 seconds via a photomask having a line-shaped pattern having a width of 30 μm, causing radiation-curing. Then, the base plate carrying the irradiated resin composition layer was immersed in a developer composed of 1.8% tetramethyl ammonium hydroxide aqueous solution (TMAH) to dissolve un-exposed parts of the resin composition, then, post bake was effected at 150° C. for 30 minutes. Thus, a core part having a line-shaped pattern having a width of 30 μm was formed.

Formation of Core Part (2):

Next, the curable resin composition for optical waveguide Z-1 was applied on a lower clad layer by a spin coat method, and dried at 80° C. for 30 minutes. Then, the composition was irradiated with ultraviolet ray having a wavelength of 365 nm and an illumination of 10 mW/cm² for 100 seconds via a photomask having a line-shaped pattern having a width of 30 μm, causing radiation-curing. The base plate subjected to this ultraviolet ray irradiation treatment was subjected to a heating treatment of keeping a temperature of 65° C. for 1 minute and 30 seconds (called post cure) using a hot plate. Then, the base plate carrying the irradiated resin composition layer was immersed in a developer composed of 1 wt % diethanolamine aqueous solution (temperature: 35° C.) to dissolve un-exposed parts of the resin composition, then, post bake was effected at 150° C. for 30 minutes. Thus, a core part having a line-shaped pattern having a width of 30 μm was formed.

Formation of Upper Clad Layer:

The lower clad layers having a core part formed by the above-mentioned methods (1) and (2) were used respectively individually, and on the upper surface of the lower clad layer having a core part provided, the curable resin composition for optical waveguide Z-2 was applied by a spin coat method, and dried at 80° C. for 30 minutes. Then, the resin composition layer was irradiated with ultraviolet ray having a wavelength of 365 nm and an illumination of 200 mW/cm² for 5 seconds, further, post bake was effected at 150° C. for 30 minutes, to form an upper clad layer having a thickness of 40 μm.

The schematic sectional view of the above-mentioned optical waveguide is as shown in FIG. 2.

### COMPARATIVE EXAMPLES 1-1 to 1-3

Optical waveguides were formed by the same manner as in Example 1-1 except that the compositions shown in Table 2 were used instead of the composition described in Example 1-1 in a lower clad layer, core part and upper clad layer.

The results are shown in Table 2.

In Table 2, transmission loss was evaluated by the following method.

Light of a wavelength of 850 nm was allowed to enter the optical waveguide in Example 1-1 and Comparative Examples 1-1 to 1-3 from one end. The quantity of light emitting from another end was measured. Loss per unit length (hereinafter, referred to as “transmission loss”) was obtained by a cut back method.

In Example 1-1, the optical waveguide had a transmission loss of as low as 0.2 dB/cm. On the other hand, in Comparative Example 1-1, un-exposed parts were not dissolved completely during a development process for forming a core part, and exposed parts causes swelling by TMAH and the core is deformed, consequently, low transmission loss was not obtained. In Comparative Example 1-2 and 1-3, a core part could be formed precisely, however, transmission loss was poor as compared with Example 1-1.

### EXAMPLES 1-2 and 1-3

Forming and Evaluation of Dry Film:

The resin compositions for optical waveguide Z-1 to Z-2 were applied by a knife edge coater on polyethylene terephthalate films (film thickness: 25 μm) respectively, then, dried at 80° C. for 30 minutes, to obtain dry films made of the resin compositions for optical waveguide. Here, the composition which could be made into a dry film was evaluated as “◯”, and the composition which could not be made into a dry film was evaluated as “x”. Those which could be made into a dry film were transferred onto a silicon base plate by a normal pressure heat roll press method (temperature: 100° C.). As a result, when uniform transfer onto a silicon base plate was possible, evaluation was “◯”, and when a dry film partially remained on a base film, or could not be transferred onto a silicon base plate, or when cracking occurred on the transferred film, evaluation was “x”. These results are summarized in Table 3.

As a result of the above-mentioned evaluation, durable dry films for optical waveguide showing a film softening temperature of 30° C. (Example 1-2) and 20° C. (Example 1-3) were obtained, in Examples 1-2 and 1-3. When these dry films were transferred onto a silicon base plate, the procedure was uniform and successful.

### COMPARATIVE EXAMPLES 1-4 TO 1-6

Dry films were manufactured in the same manner as for Examples 1-2 and 1-3 except the use of the resin compositions for optical waveguide Z-3 to Z-5.

The results are shown in Table 3. In Comparative Example 1-4, a curable dry film for optical waveguide showing a film softening temperature of 80° C. was obtained. However, transferring onto a silicon base plate was impossible. In Comparative Example 1-5, curable dry films for optical waveguide showing a film softening temperature of 40° C. could be obtained, however, crack and fracture were observed in some dry films. Though transferring onto a silicon base plate was possible, crack and fracture were observed on the film after transferring. In Comparative Example 1-6, a curable dry film for optical waveguide could not be obtained. When the softening temperature of the composition in Comparative Example 1-6 was measured by TMA to find a value of −30° C. or lower.

### EXAMPLE 1-4

Forming of Optical Waveguide by Dry Film and Evaluation Thereof:

Curable dry films for optical waveguide were manufactured by using the curable resin compositions for optical waveguide Z-1 and Z-2, and an optical waveguide was formed using these dry films.

Formation of Lower Clad Layer:

The curable dry film for optical waveguide ZD-2 composed of the curable resin composition for optical waveguide Z-2 was transferred onto the surface of a silicon base plate by a normal pressure heat roll press method (temperature: 100° C.), and irradiated with ultraviolet ray having a wavelength of 365 nm and an illumination of 200 mW/cm² for 5 seconds, then, heat-cured at 150° C. for 30 minutes, to obtain a lower clad layer having a thickness of 40 μm.

Formation of Core Part:

Next, the curable dry film for optical waveguide ZD-1 composed of the curable resin composition for optical waveguide Z-1 was transferred onto a lower clad layer by a normal pressure heat roll press method (temperature: 100° C.), and irradiated with ultraviolet ray having a wavelength of 365 nm and an illumination of 10 mW/cm² via a photomask having a line-shaped pattern having a width of 30 μm for 100 seconds, to partially cure the dry film ZD-1. Then, the base plate carrying ZD-1 irradiated with ultraviolet ray was immersed in a developer composed of 1.8% tetramethyl ammonium hydroxide aqueous solution (TMAH) to dissolve un-exposed parts of the film. Thus, a core part having a line-shaped pattern having a width of 30 μm was formed.

Formation of Upper Clad Layer:

The curable dry film for optical waveguide ZD-2 was transferred onto the upper surface of the lower clad layer having a core part by a normal pressure heat roll press method (temperature: 100° C.), and pre-baked at 120° C. for 30 minutes using a hot plate. Then, the film composed of ZD-2 was irradiated with ultraviolet ray having a wavelength of 365 nm and an illumination of 200 mW/cm² for 5 seconds, and post-baked at 150° C. for 30 minutes, to manufactured an optical waveguide of Example 1-4. The schematic sectional view of the optical waveguide of Example 1-4 is as shown in FIG. 2.

The transmission loss of the optical waveguide manufactured in Example 1-4 was evaluated by a cut back method (by the same method as described above) to find an excellent value of 0.21 dB/cm.

A line-shaped pattern having a width of 30 μm was formed in the same manner as for the formation of core part (2) except that post cure was not effected. A pattern of 30±8 μm was obtained, while a pattern of 30±3 μm was obtained when post cure was effected. Namely, swelling resistance against a developer is improved, and more excellent shape stability of a core part is obtained, by post cure.

TABLE 1

| Curing resin composition | | | | | | |
|---|---|---|---|---|---|---|
| for optical waveguide | | Z-1 | Z-2 | Z-3 | Z-4 | Z-5 |
| Component A | A-1 | 61.4 | | | | |
| | A-2 | | 59.4 | | | |
| | A-3 | | | 61.5 | | |
| | A-4 | | | | 62.2 | |
| | A-5 | | | | | 68.0 |
| Component B | Aronix M-8100 | 12.3 | | 12.3 | 19.4 | |
| | Trimethylolpropanetriacrylate | 6.1 | 17.8 | 6.1 | 12.6 | |
| | KAYARAD R-604 | | | | | 29 |
| Component C | Epicoat EP-828EL | 19.5 | | 19.5 | | |
| | EXA-750 | | 21.6 | | | |
| Component D | Irgacure 907 | 0.6 | 0.6 | 0.6 | 5.8 | 3.0 |
| | N-(trifluoromethylsulfonyloxy)-1, | | 0.6 | | | |
| | 8-naphthalenedicarboxyimide | | | | | |
| Total | | 100.0 | 100.0 | 100.0 | 100.0 | 100.0 |

TABLE 2

| | | Comparative | | |
|---|---|---|---|---|
| | Example | Example 1 | | |
| | 1-1 | 1-1 | 1-2 | 1-3 |
| Constitution of optical waveguide | | | | |
| Lower clad layer | Z-2 | Z-2 | Z-2 | Z-2 |
| Core part | Z-1 | Z-3 | Z-4 | Z-5 |
| Upper clad layer | Z-2 | Z-2 | Z-2 | Z-2 |
| Difference in refractive index | 1.5 | 1.5 | 1.5 | 1.5 |
| (Δn) (%) of core clad | | | | |
| at 850 nm | | | | |
| Optical waveguide property | | | | |
| Precision of core shape | ◯ | X | ◯ | ◯ |
| Transmission loss (dB/cm) | 0.2 | | 0.4 | 0.3 |

TABLE 3

| | | | Compar- | Compar- | Compar- |
|---|---|---|---|---|---|
| | Exam- | Exam- | ative | ative | ative |
| | ple | ple | Example | Example | Example |
| | 1-2 | 1-3 | 1-4 | 1-5 | 1-6 |
| Curable resin | Z-1 | Z-2 | Z-3 | Z-4 | Z-5 |
| composition for | | | | | |
| optical waveguide | | | | | |
| Softening point | 30° C. | 20° C. | 100° C. | 40° C. | <−30° C. |
| Film formation | ◯ | ◯ | ◯ | ◯ | X |
| Transferring | ◯ | ◯ | X | X | X |
| property | | | | | |

Next, the second aspect of the present invention will be illustrated further specifically by the following examples, but the scope of the invention is not limited to these examples.

### SYNTHESIS EXAMPLE OF CARBOXYL GROUP-CONTAINING URETHANE COMPOUNDS (A-1) AND (A-2)

Carboxyl group-containing urethane compounds A-1 and A-2 were obtained in the same manner as in the examples of the first aspect of the present invention.

### SYNTHESIS EXAMPLE OF CARBOXYL GROUP-CONTAINING URETHANE COMPOUND (A-3) (COMPARATIVE EXAMPLE)

A methyl ethyl ketone solvent was charged in suitable amount in a flask equipped with a reflux equipment, and 35.7 g of dimethylolbutanoic acid having two hydroxyl groups and one carboxyl group in one molecule, 12.2 g of neopentyl glycol having two hydroxyl groups in one molecule, 50.0 g of trimethylhexamethylene diisocyanate having two isocyanate groups in the molecule, and 500 ppm of dibutyltin dilaurate as a reaction catalyst were added therein, and the mixture was heated up to 75° C. while stirring. After heating up to 75° C., they were reacted under stir for 12 hours while maintaining this temperature to obtain the intended carboxyl group-containing urethane compound A-3.

Preparation of Dry Film ZD-1

61.5 parts by weight of the above-mentioned carboxyl group-containing urethane compound A-1, 12.3 parts by weight of Aronix M-8100 (manufactured by Toagosei Co., Ltd., trade name) as a polymerizable unsaturated compound, 6.1 parts by weight of trimethylolpropane triacrylate, 19.5 parts by weight of Epicoat EP-828EL (manufactured by Japan Epoxy Resin K.K., trade name) as a cross-linking agent, and 0.6 parts by weight of Irgacure 907 (manufactured by Chiba Specialty Chemicals) as a photo-polymerization initiator were added and mixed in a methyl ethyl ketone solvent, to obtain a uniform solution.

Subsequently, this solution was applied on a polyethylene terephthalate film (thickness: 25 μm) by a knife edge coater, then, dried at 80° C. for 30 minutes, to obtain a curable dry film ZD-1 having a thickness of 30 μm.

The glass transition temperature of this dry film was measured by TMA to find a value of 30° C., and the glass transition temperature after irradiation with ultraviolet ray having a wavelength of 365 nm and an illumination of 10 mW/cm² for 100 seconds was 50° C.

Preparation of Dry Film ZD-2

21.7 parts by weight of the above-mentioned carboxyl group-containing urethane compound A-2, 27.6 parts by weight of hydrogenated bisphenol A diclycidyl ether having a structure shown below (viscosity: 2200 mPa·s (25° C.), epoxy equivalent: 216 g/eq) as a cross-linking agent, and 0.7 parts by weight of N-(trifluoromethylsulfonyloxy)-1,8-naphthalenedicarboxyimide (thermal decomposition temperature: 140° C.) as a light acid generator were added and mixed in a methyl ethyl ketone solvent, to obtain a uniform solution.

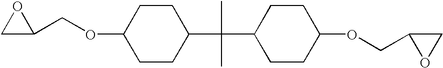

Subsequently, this solution was applied on a polyethylene terephthalate film (thickness: 25 μm) by a knife edge coater, then, dried at 80° C. for 30 minutes, to obtain a curable dry film ZD-2 having a thickness of 40 μm. The glass transition temperature of this dry film was measured by TMA to find a value of 18° C.

Preparation of Dry Film ZD-3

71.7 parts by weight of the above-mentioned carboxyl group-containing urethane compound A-3, 27.6 parts by weight of EXA-750 (manufactured by Dainippon Ink & Chemicals, Inc., trade name) as a cross-linking agent, and 0.7 parts by weight of N-(trifluoromethylsulfonyloxy)-1,8-naphthalenedicarboxyimide (thermal decomposition temperature: 140° C.) as a light acid generator were added and mixed in a methyl ethyl ketone solvent, to obtain a uniform solution.

Subsequently, this solution was applied on a polyethylene terephthalate film (thickness: 25 μm) by a knife edge coater, then, dried at 80° C. for 30 minutes, to obtain a curable dry film ZD-3 having a thickness of 40 μm. The glass transition temperature of this dry film was measured by TMA to find a value of 82° C.

The compositions and the glass transition temperatures by TMA of the above-mentioned dry films are summarized in Table 4.

TABLE 4

| Curable dry film | ZD-1 | ZD-2 | ZD-3 |
|---|---|---|---|
| Compound A-1 | 61.5 | | |
| Compound A-2 | | 71.7 | |
| Compound A-3 | | | 71.7 |
| Aronix M-8100 | 12.3 | | |
| Trimethylolpropane triacrylate | 6.1 | | |
| Epicoat EP-828EL | 19.5 | | |
| EXA-750 | | 27.6 | 27.6 |
| Irgacure 907 | 0.6 | | |
| N-(trifluoromethylsulfonyloxy)-1,8- | | 0.7 | 0.7 |
| naphthalenedicarboxyimide | | | |
| Total | 100.0 | 100.0 | 100.0 |
| Dry film glass transition temperature | 30° C. | 18° C. | 82° C. |
| Glass transition temperature after | 50° C. | | |
| irradiation with UV | | | |

Formation of Lower Clad Layer and Core Part (1):

(1-1) For formation of a lower clad layer, the dry film ZD-2 was transferred onto the surface of a silicon base plate by a normal pressure heat roll press method (temperature: 100° C.), and irradiated with ultraviolet ray having a wavelength of 365 nm and an illumination of 100 mW/cm² for 10 seconds, then, heat-cured at 150° C. for 30 minutes using a hot plate, to obtain a lower clad layer having a thickness of 20 μm. The refractive index of this clad layer after curing was measured at a wavelength of 850 nm using an Abbe refractometer, to find a value of 1.497.

(1-2) Next, for formation of a core part, the dry film ZD-1 was transferred onto the lower clad layer by a normal pressure roll press method (temperature: 100° C.). Then, the film having a thickness of 30 μm composed of the dry film ZD-1 was irradiated with ultraviolet ray having a wavelength of 365 nm and an illumination of 10 mW/cm² via a photomask having a line-shaped pattern having a width of 30 μm for 100 seconds, to cure the film with ultraviolet ray. Then, the base plate carrying the film irradiated with ultraviolet ray was immersed in a developer composed of 1.5 wt % sodium carbonate aqueous solution (temperature: 35° C.), to dissolve un-exposed parts of the film. Thus, a core part having a line-shaped pattern having a width of 30 μm was formed. The refractive index of this core part was measured at a wavelength of 850 nm using an Abbe refractometer, to find a value of 1.520. It was also confirmed that a core of rectangular shape having a line width of 30 μm was formed with good precision, at this stage.

Formation of Lower Clad Layer and Core Part (2):

(2-1) For formation of a lower clad layer, the dry film ZD-2 was transferred onto the surface of a silicon base plate by a normal pressure heat roll press method (temperature: 100° C.), and irradiated with ultraviolet ray having a wavelength of 365 nm and an illumination of 100 mW/cm² for 10 seconds, then, heat-cured at 150° C. for 30 minutes using a hot plate, to obtain a lower clad layer having a thickness of 20 μm. The refractive index of this clad layer after curing was measured at a wavelength of 850 nm using an Abbe refractometer, to find a value of 1.497.

(2-2) Next, for formation of a core part, the dry film ZD-1 was transferred onto the lower clad layer by a normal pressure roll press method (temperature: 100° C.). Then, the film having a thickness of 30 μm composed of the dry film ZD-1 was irradiated with ultraviolet ray having a wavelength of 365 nm and an illumination of 10 mW/cm² via a photomask having a line-shaped pattern having a width of 30 μm for 100 seconds, to cure the film with ultraviolet ray. The base plate carrying the film subjected to this ultraviolet ray irradiation was subjected to a heating treatment of keeping a temperature of 65° C. for 1 minute and 30 seconds (called post cure) using a hot plate. Then, the base plate carrying the film subjected to this heating treatment was immersed in a developer composed of 1 wt % diethanolamine aqueous solution (temperature: 35° C.), to dissolve un-exposed parts of the film. Thus, a core part having a line-shaped pattern having a width of 30 μm was formed. The refractive index of this core part was measured at a wavelength of 850 nm using an Abbe refractometer, to find a value of 1.520. It was also confirmed that a core of rectangular shape having a line width of 30 μm was formed with good precision, at this stage. By impacting a heating treatment after irradiation with ultraviolet ray for forming a core part, the construct of the shape of the core part could be further improved using a diethanolamine aqueous solution as a developer.

### EXAMPLE 2-1

After formation (1) of a lower clad layer and a core part, the dry film ZD-2 (glass transition temperature: 18° C.) was transferred onto the upper surface of the lower clad layer having a core part (glass transition temperature: 50° C.) by a normal pressure heat roll press method (temperature: 100° C.), for formation of an upper clad layer. Thereafter, post bake was conducted at 150° C. for 60 minutes, to obtain an optical waveguide. The refractive index of this upper clad layer after curing was measured at a wavelength of 850 nm using an Abbe refractometer, to find a value of 1.497. The resulted optical waveguide had a structure shown in FIG. 3. Resultantly, in the above-mentioned method, a rectangular shape having a core height of 30±3 μm and a core width of 30±3 μm was formed. Light of a wavelength of 850 nm was allowed to enter the resulted optical waveguide from one end, and the quantity of light emitting from another end was measured. And the waveguide transmission loss was measured by a cut back method to find a value of 0.4 dB/cm.

### EXAMPLE 2-2

An optical waveguide was obtained in the same manner as in Example 2-1 except that pre-bake was conducted at 120° C. for 30 minutes using a hot plate before post-bake. The refractive index after curing an upper clad layer was 1.497. The resulted optical waveguide had a structure shown in FIG. 3. Resultantly, in the above-mentioned method, a rectangular shape having a core height of 30±3 μm and a core width of 30±3 μm was formed. The waveguide transmission loss of the resulted optical waveguide was measured by a cut back method to find a value of 0.2 dB/cm.

### EXAMPLE 2-3

An optical waveguide was obtained in the same manner as in Example 2-1 except that pre-bake was conducted at 120° C. for 30 minutes using a hot plate before post-bake, further thereafter, the film composed of the dry film ZD-2 was irradiated with ultraviolet ray having a wavelength of 365 nm and an illumination of 100 mW/cm² for 10 seconds before conducting post bake. The refractive index after curing an upper clad layer was 1.497. The resulted optical waveguide had a structure shown in FIG. 3. Resultantly, in the above-mentioned method, a rectangular shape having a core height of 30±3 μm and a core width of 30±3 μm was formed. The waveguide transmission loss of the resulted optical waveguide was measured by a cut back method to find a value of 0.2 dB/cm.

### EXAMPLE 2-4

An optical waveguide was obtained in the same manner as in Example 2-1 except that the formation (2) of a lower clad layer and a core part was conducted instead of the formation (1) of a lower clad layer and a core part. The refractive index after curing an upper clad layer was 1.497. The resulted optical waveguide had a structure shown in FIG. 3. Resultantly, in the above-mentioned method, a rectangular shape having a core height of 30±3 μm and a core width of 30±3 μm was formed. The waveguide transmission loss of the resulted optical waveguide was measured by a cut back method to find a value of 0.4 dB/cm.

### EXAMPLE 2-5

An optical waveguide was obtained in the same manner as in Example 2-4 except that pre-bake was conducted at 120° C. for 30 minutes using a hot plate before post-bake. The refractive index after curing an upper clad layer was 1.497. The resulted optical waveguide had a structure shown in FIG. 3. Resultantly, in the above-mentioned method, a rectangular shape having a core height of 30±3 μm and a core width of 30±3 μm was formed. The waveguide transmission loss of the resulted optical waveguide was measured by a cut back method to find a value of 0.2 dB/cm.

### EXAMPLE 2-6

An optical waveguide was obtained in the same manner as in Example 2-4 except that pre-bake was conducted at 120° C. for 30 minutes using a hot plate before post-bake, further thereafter, the film composed of the dry film ZD-2 was irradiated with ultraviolet ray having a wavelength of 365 nm and an illumination of 100 mW/cm² for 10 seconds before conducting post bake. The refractive index after curing an upper clad layer was 1.497. The resulted optical waveguide had a structure shown in FIG. 3. Resultantly, in the above-mentioned method, a rectangular shape having a core height of 30±3 μm and a core width of 30±3 μm was formed. The waveguide transmission loss of the resulted optical waveguide was measured by a cut back method to find a value of 0.2 dB/cm. An optical waveguide was formed in the same manner as described above except that post cure was not conducted, consequently, a rectangular shape having a core height of 30±3 μm and a core width of 30±3 μm was formed. Namely, swelling resistance against a developer is improved, and more excellent shape stability of a core part is obtained, by post cure.

### COMPARATIVE EXAMPLE 2-1

After formation (1) of a lower clad layer and a core part, the dry film ZD-3 (glass transition temperature: 82° C.) was transferred onto the upper surface of the lower clad layer having a core part (glass transition temperature: 50° C.) by a normal pressure heat roll press method (temperature: 100° C.), for formation of an upper clad layer. Thereafter, post bake was conducted at 140° C. for 60 minutes, to obtain an optical waveguide. However, the resulted optical waveguide revealed deformation of the core part as shown in FIG. 4, and an excellent optical waveguide could not be formed. Light of a wavelength of 850 nm was allowed to enter the resulted optical waveguide from one end, and the quantity of light emitting from another end was measured. And the waveguide transmission loss was measured by a cut back method to find a value of significantly higher than 1.0 dB/cm, and guiding wave of light could not be confirmed.

### COMPARATIVE EXAMPLE 2-2

After formation (1) of a lower clad layer and a core part, the dry film ZD-2 (glass transition temperature: 18° C.) was transferred onto the upper surface of the lower clad layer having a core part (glass transition temperature: 50° C.) by a normal pressure heat roll press method (temperature: 25° C.), for formation of an upper clad layer. Thereafter, post bake was conducted at 140° C. for 60 minutes, to obtain an optical waveguide. However, the resulted optical waveguide revealed foaming in the upper clad layer as shown in FIG. 5. Light of a wavelength of 850 nm was allowed to enter the resulted optical waveguide from one end, and the quantity of light emitting from another end was measured. And the waveguide transmission loss was measured by a cut back method to find a value of 1.0 dB/cm, that is, the resulted optical waveguide was not an excellent optical waveguide.

1. A curable resin composition for optical waveguide comprising, as essential components,
a carboxyl group-containing urethane compound (A),
a polymerizable unsaturated compound (B),
a compound (C) containing two or more ring-opening polymerizable functional groups in the molecule, and,
a radiation polymerization initiator (D).

2. The curable resin composition for optical waveguide according to claim 1, wherein the carboxyl group-containing urethane compound (A) is a reaction product of a polyhydroxycarboxylic acid compound (a) having two or more hydroxyl groups in one molecule and one or more carboxyl groups in one molecule with a polyisocyanate compound (b).

3. A dry film for forming an optical waveguide composed of a curable resin composition comprising, as essential components,
a carboxyl group-containing urethane compound (A),
a polymerizable unsaturated compound (B),
a compound (C) containing two or more ring-opening polymerizable functional groups in the molecule, and,
a radiation polymerization initiator (D),
and the dry film has a softening temperature of 0° C. to 80° C.

4. An optical waveguide formed by using a dry film having a lower clad layer, core part and upper clad layer wherein at least one of these lower clad layer, core part and upper clad layer is composed of a curable resin composition comprising, as essential components,
a carboxyl group-containing urethane compound (A),
a polymerizable unsaturated compound (B),
a compound (C) containing two or more ring-opening polymerizable functional groups in the molecule, and,
a radiation polymerization initiator (D),
and the dry film has a softening temperature of 0° C. to 80° C.

5. The optical waveguide according to claim 4, wherein the difference in refractive indexes between the clad layer and core part is 0.1% or more.

6. A method for forming an optical waveguide comprising,
forming a core part (II) composed of a cured resin on the surface of a lower clad layer (I),
laminating a dry film composed of a thermosetting resin composition on the surface of the lower clad layer (I) and core part (II) by heating, and,
curing the film to form an upper clad layer (III),
wherein the glass transition temperature of said dry film is lower by 10° C. or more than the glass transition temperature of the cured resin forming the core part (II), and the laminating temperature of said dry film is higher by 10° C. or more than the glass transition temperature of the dry film.

7. The method for forming an optical waveguide according to claim 6, wherein the thermosetting resin composition constituting the dry film contains at least one of a heat latent catalyst and a light latent catalyst.

8. The method for forming an optical waveguide according to claim 7, wherein a dry film is laminated on the surface of the lower clad layer (I) and core part (II), and then pre-bake is conducted before conducting post-bake for curing the dry film.

9. The method for forming an optical waveguide according to claim 8, wherein the pre-bake temperature is lower than the dissociation temperature of the heat latent catalyst or light latent catalyst, and the post-bake temperature is not lower than the dissociation temperature of the heat latent catalyst or light latent catalyst.

10. The method for forming an optical waveguide according to claim 8, wherein after pre-bake, irradiation with active energy ray is conducted, and then post-bake is conducted to cure the upper clad layer (III).

11. The method for forming an optical waveguide according to claim 6, wherein the difference in refractive indexes between the core part (II) from the lower clad layer (I) and upper clad layer (III) is 0.1% or more.

12. An optical waveguide obtained by the method for forming an optical waveguide according to claim 6.
